(19) United States
(12) Patent Application Publication
(10) Pub. No.: US 2024/0097464 A1
(43) Pub. Date: Mar. 21, 2024

(54) ACCOMMODATING BOX

(71) Applicant: MAKITA CORPORATION, Anjo-shi (JP)

(72) Inventor: Akira NIWA, Anjo-shi (JP)

(73) Assignee: MAKITA CORPORATION, Anjo-shi (JP)

(21) Appl. No.: 18/462,505

(22) Filed: Sep. 7, 2023

(30) Foreign Application Priority Data
Sep. 21, 2022 (JP) 2022-149950

(51) Int. Cl. H02J 7/00; H01M 10/46

(52) U.S. Cl. CPC H02J 7/0045; H01M 10/46

(57) ABSTRACT

An accommodating box may include: a case; and a plurality of battery attaching units supported by the case. Each of the battery packs may include an engagement member configured to engage with the electrical device when the battery pack is attached to the electrical device, engagement between the battery pack and the electrical device being released by a user's operation on the engagement member. Each of the battery attaching units may include: a terminal member unit configured to be electrically connected to one of the battery packs when the battery pack is attached to the battery attaching unit; and a holding member that holds the terminal member unit. The holding member may not be engaged with the engagement member of the battery pack when the battery pack is attached to the battery attaching unit.

### REFERENCE TO RELATED APPLICATIONS

This application claims priority to Japanese Patent Application No. 2022-149950, filed on Sep. 21, 2022, the entire contents of which are hereby incorporated by reference into the present application.

### TECHNICAL FIELD

The disclosure herewith relates to an accommodating box configured to charge battery packs in a state in which the battery packs are accommodated in the accommodating box, the battery pack configured to be used by being attached to an electrical device.

### BACKGROUND ART

Japanese Patent Application Publication No. 2016-62808 describes an accommodating box. This accommodating box can charge battery packs in the state in which the battery packs are accommodated in the accommodating box. The battery packs are used by being attached to an electrical device. The accommodating box includes a case and a plurality of battery attaching units supported by the case. Each of the battery packs is detachably attached to one of the plurality of the battery attaching units. Each of the battery packs includes a locking claw and an unlock button for moving the locking claw. Each of the battery attaching units includes an engagement recess into which its corresponding locking claw is to be hooked. When the unlock button is pushed down in the state where the battery pack is attached to the battery attaching unit, the locking clow is released from the engagement recess. Due to this, the battery pack becomes detachable from the battery attaching unit.

### DESCRIPTION

In order to detach the battery packs from the battery attaching units in the accommodating box as described above, the unlock buttons need to be pushed down and the locking claws need to be released from the engagement recesses. Due to this, the battery packs cannot easily be detached from the battery attaching units. The disclosure herein provides art that facilitates detachment of battery packs from battery attaching units.

The present disclosure discloses an accommodating box. An accommodating box disclosed herein may be configured to charge battery packs in a state in which the battery packs are accommodated in the accommodating box, the battery packs configured to be used by being attached to an electrical device. The accommodating box may comprise: a case; and a plurality of battery attaching units supported by the case. Each of the battery packs may be configured to be detachably attached to one of the plurality of the battery attaching units. Each of the battery packs may comprise an engagement member configured to engage with the electrical device when the battery pack is attached to the electrical device, engagement between the battery pack and the electrical device being released by a user's operation on the engagement member. Each of the battery attaching units may comprise: a terminal member unit configured to be electrically connected to one of the battery packs when the battery pack is attached to the battery attaching unit; and a holding member that holds the terminal member unit. The holding member may not be engaged with the engagement member of the battery pack when the battery pack is attached to the battery attaching unit.

According to the above configuration, when each of the battery packs is attached to one of the battery attaching units, the engagement member of the battery pack does not engage with the holding member of the battery attaching unit. Due to this, when the battery pack is to be detached from the battery attaching unit, work for releasing the engagement of the engagement member and the holding member becomes unnecessary. Thus, the battery pack can easily be detached from the battery attaching unit.

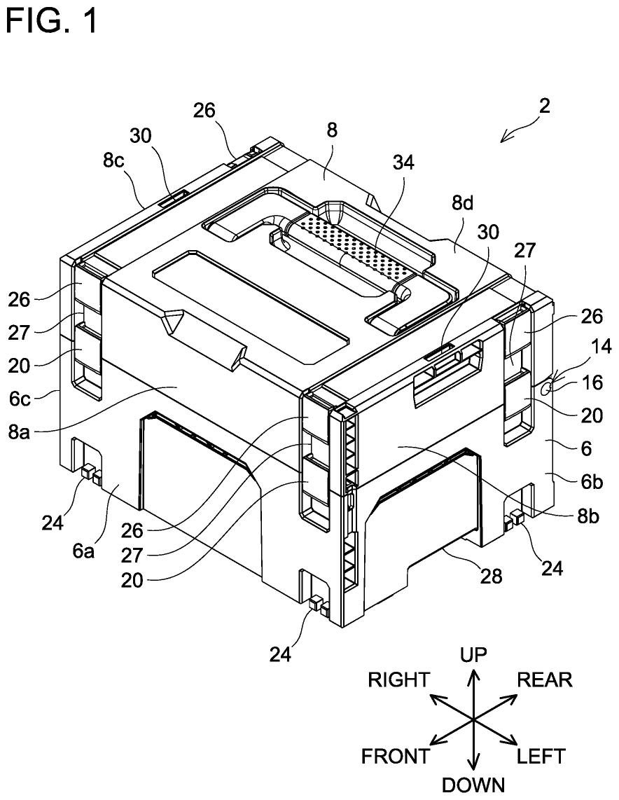

FIG. 1 is a perspective view of an accommodating box 2 of an embodiment in the state where a case cover 8 is in a closing position.

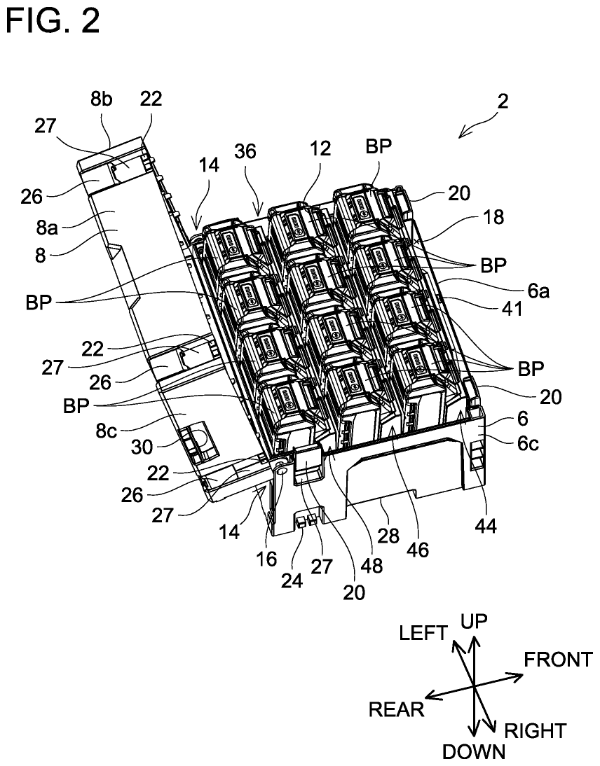

FIG. 2 is a perspective view of the accommodating box 2 of the embodiment in the state where the case cover 8 is in an opening position.

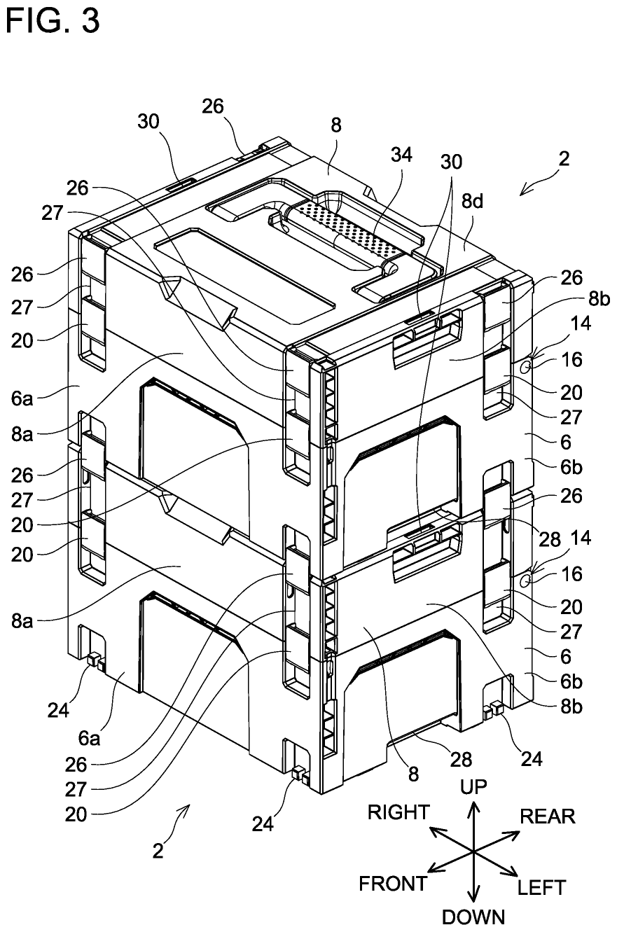

FIG. 3 is a perspective view in which two accommodating boxes 2 of the embodiment are stacked vertically.

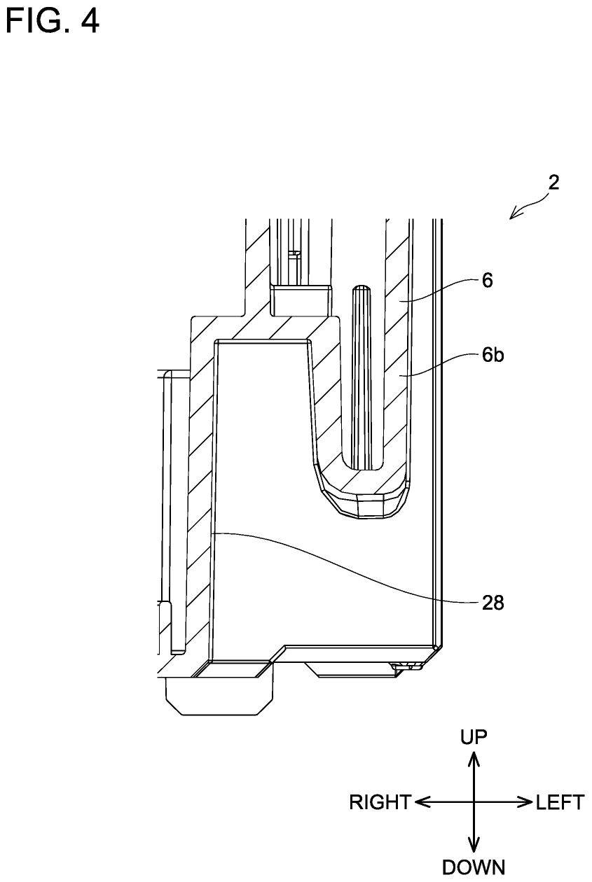

FIG. 4 is a cross-sectional view of an area including a lower finger hook groove 28 of the accommodating box 2 of the embodiment.

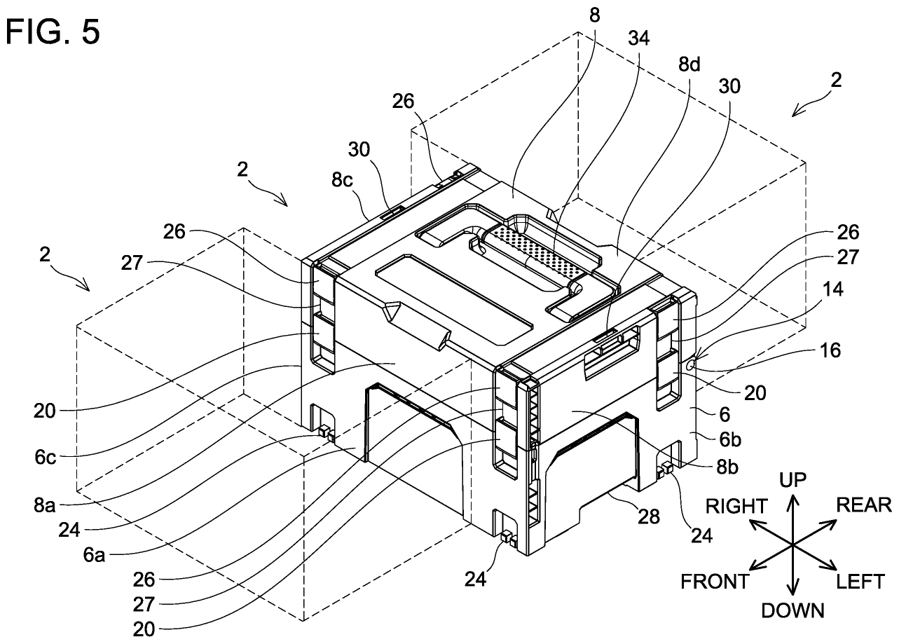

FIG. 5 is a perspective view of three accommodating boxes 2 of the embodiment when the accommodating box 2 at the center is drawn out from between the other accommodating boxes 2 on both ends.

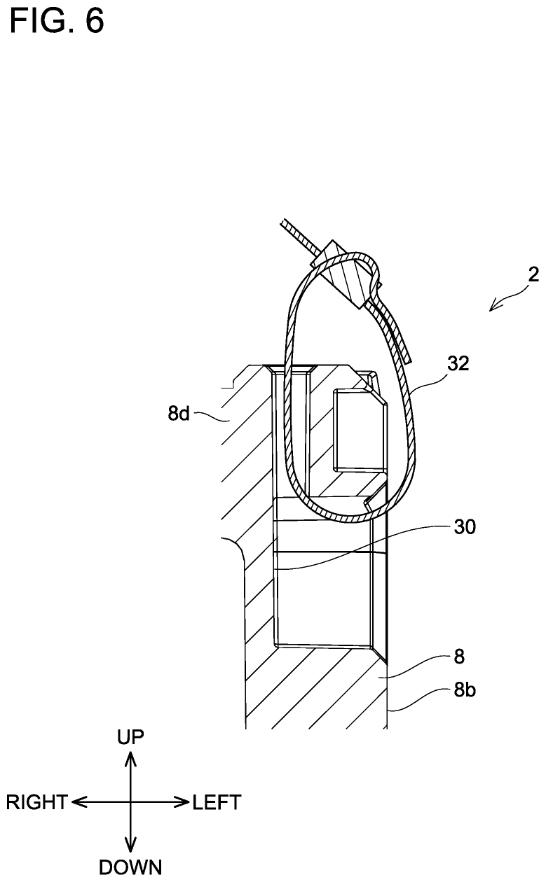

FIG. 6 is a cross-sectional view of an area including a belt attachment hole 30 of the accommodating box 2 of the embodiment.

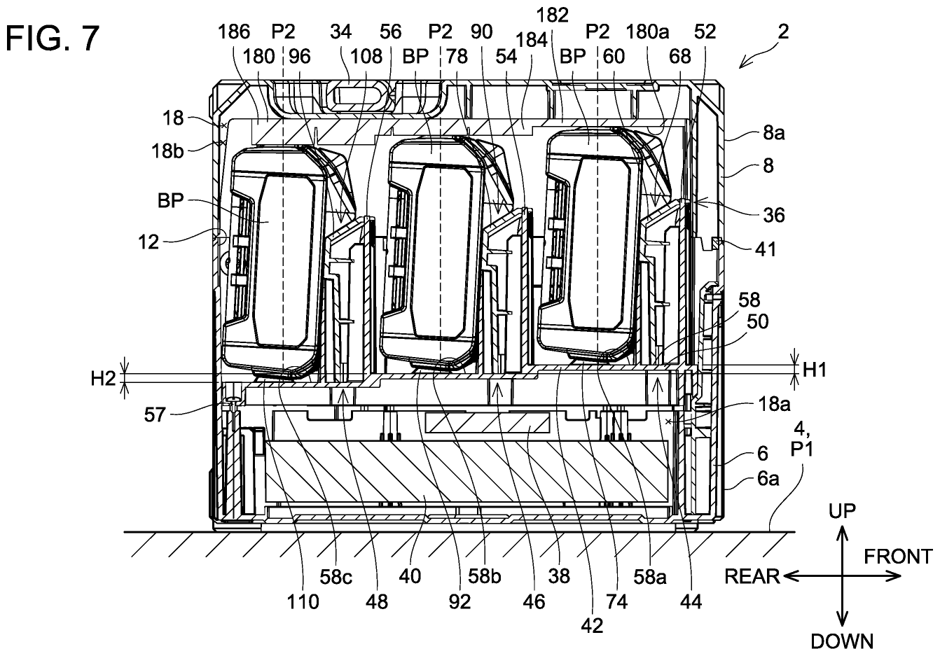

FIG. 7 is a cross-sectional view of the accommodating box 2 of the embodiment in the state where the case cover 8 is in the closing position.

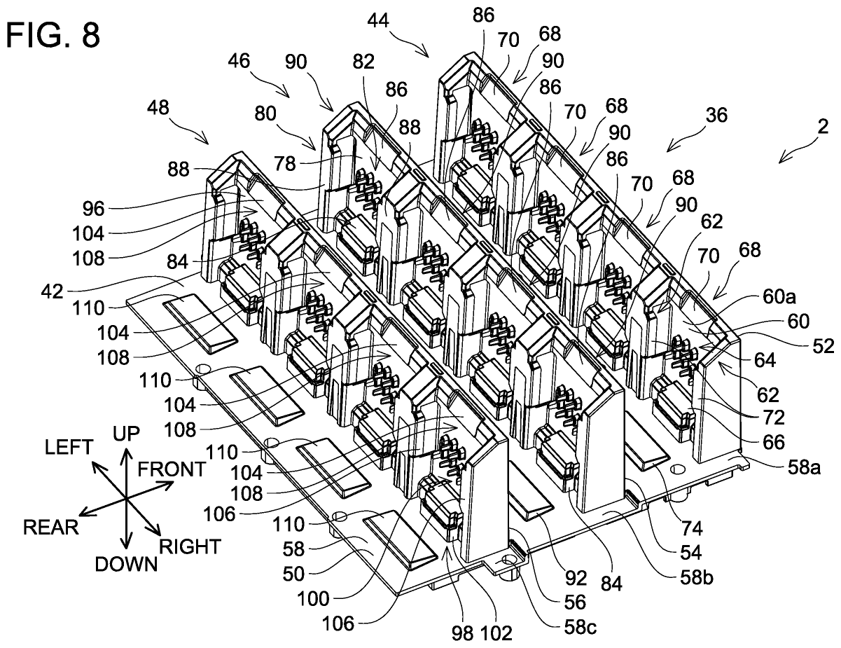

FIG. 8 is a perspective view of a battery attaching unit 36 of the embodiment.

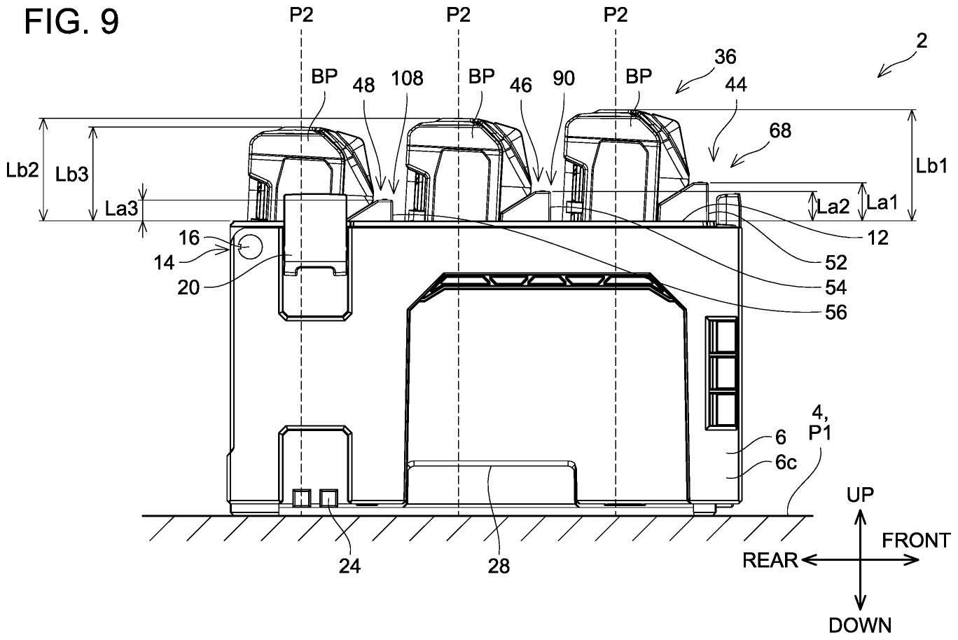

FIG. 9 is a side view of the accommodating box 2 of the embodiment in the state where the case cover 8 is detached.

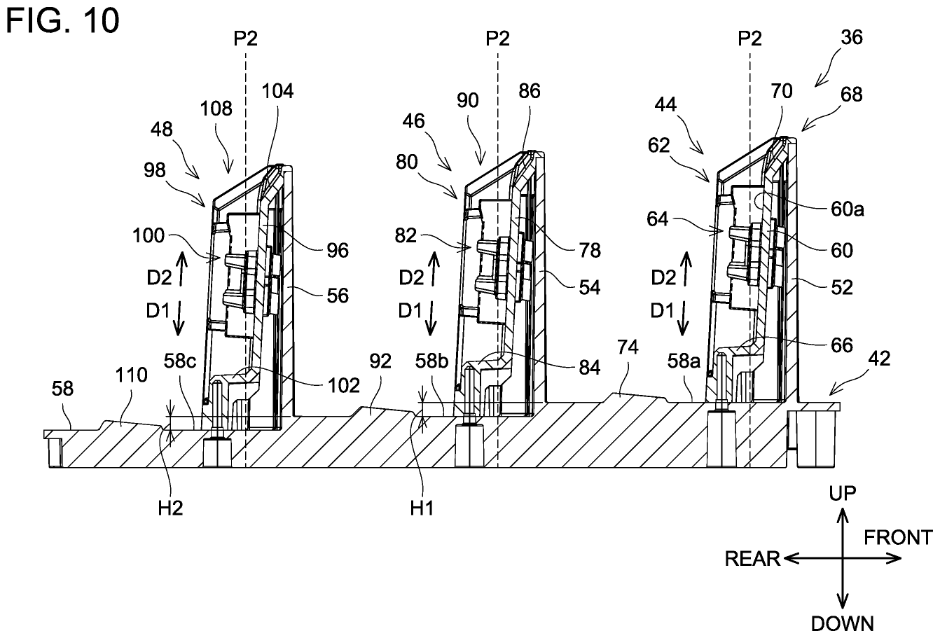

FIG. 10 is a cross-sectional view of the battery attaching unit 36 of the embodiment.

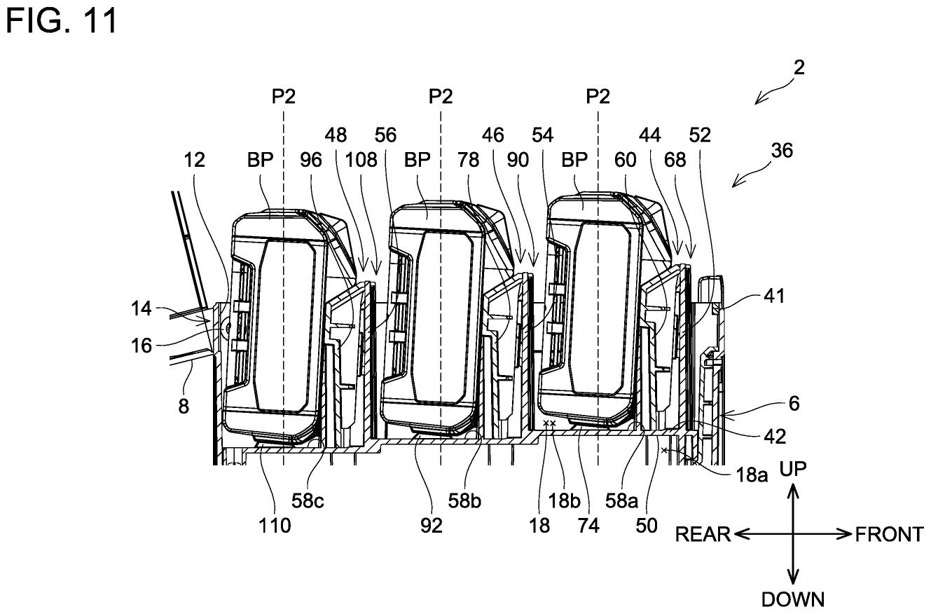

FIG. 11 is a cross-sectional view of a portion of the battery attaching unit 36 when the case cover 8 is in the opening position in the accommodating box 2 of the embodiment.

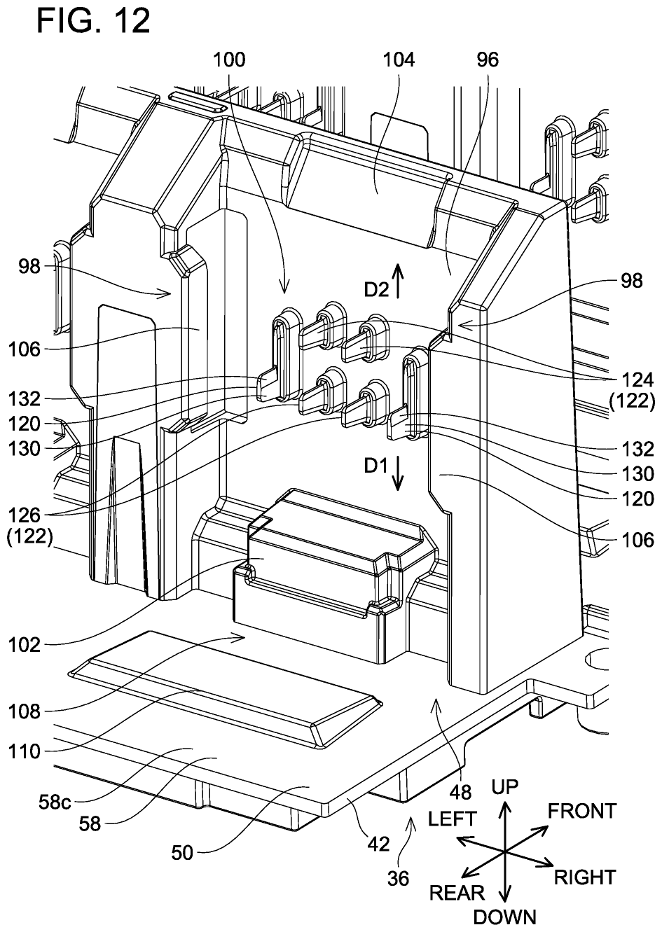

FIG. 12 is a perspective view of an area including a rear battery attaching unit 48 included in the battery attaching unit 36 of the embodiment.

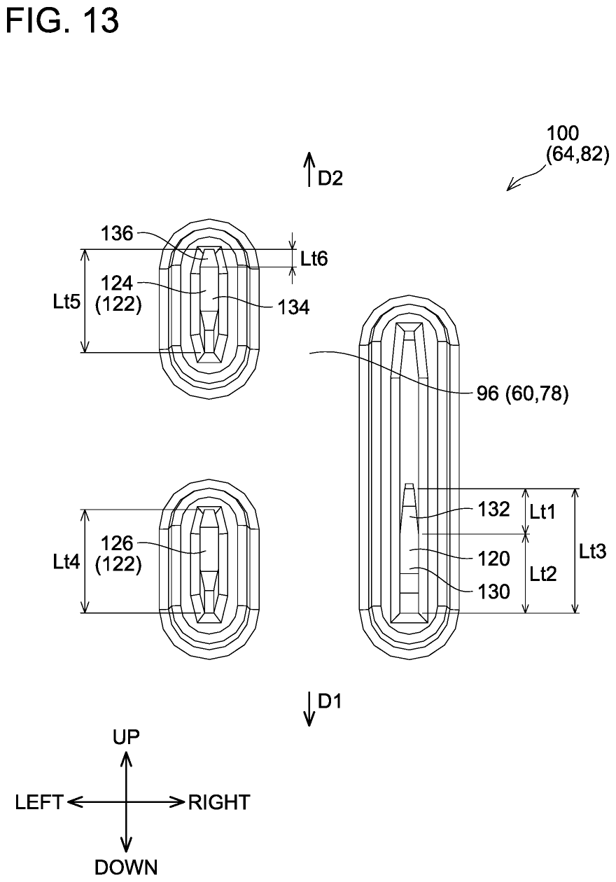

FIG. 13 is a rear view of an area including a terminal member unit 64, 82, or 100 of the battery attaching unit 36 of the embodiment.

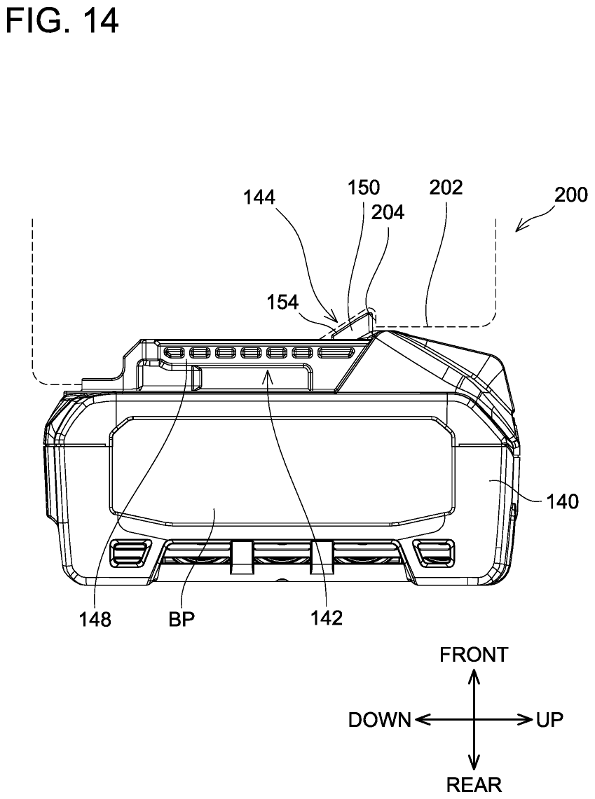

FIG. 14 is a side view of a battery pack BP of the embodiment.

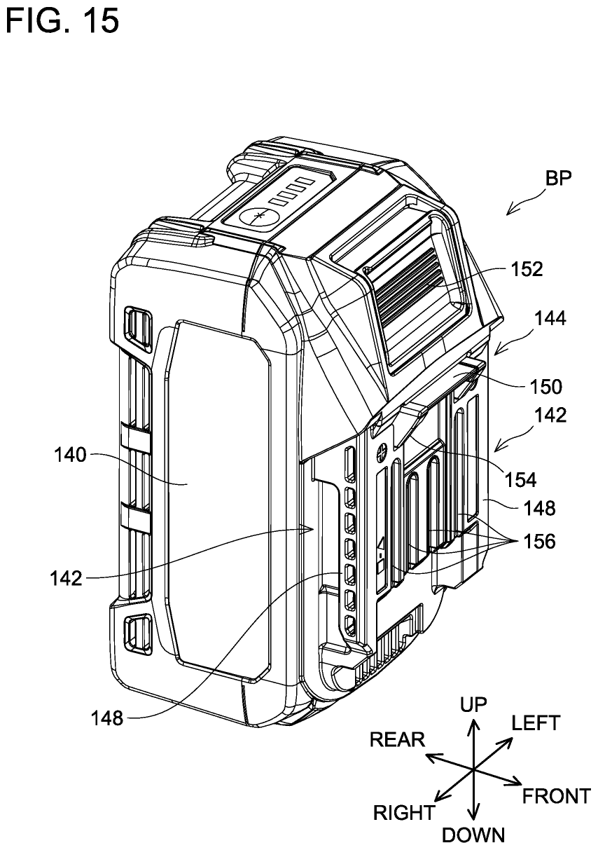

FIG. 15 is a perspective view of the battery pack BP of the embodiment.

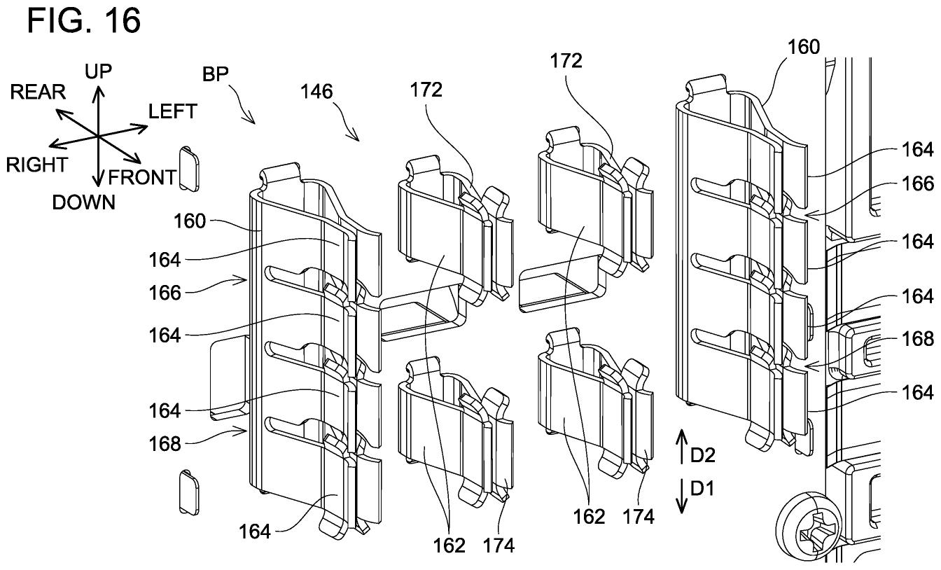

FIG. 16 is a perspective view of an area including a battery terminal member unit 146 of the battery pack BP of the embodiment.

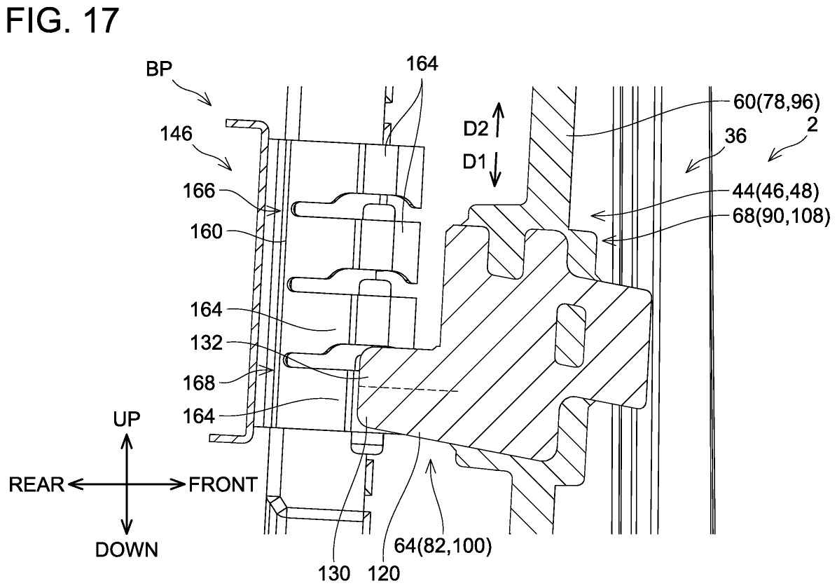

FIG. 17 is a cross-sectional view showing a positional relationship of a charge terminal member 120 of the battery attaching unit 36 and a battery charge terminal member 160 of the battery pack BP of the embodiment.

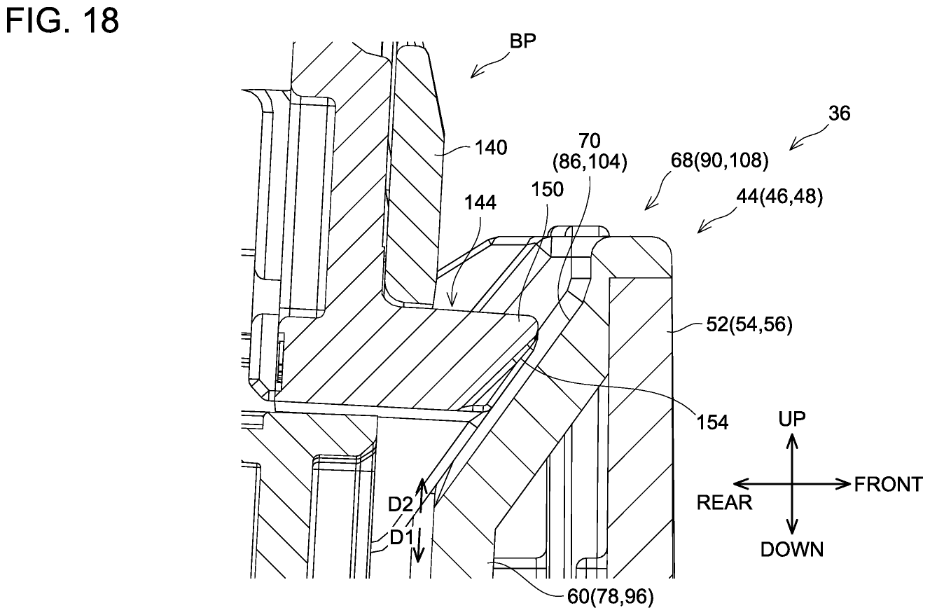

FIG. 18 is a vertical cross-sectional view of an area including a relief groove 70, 86, or 104 of the battery attaching unit 36 of the embodiment.

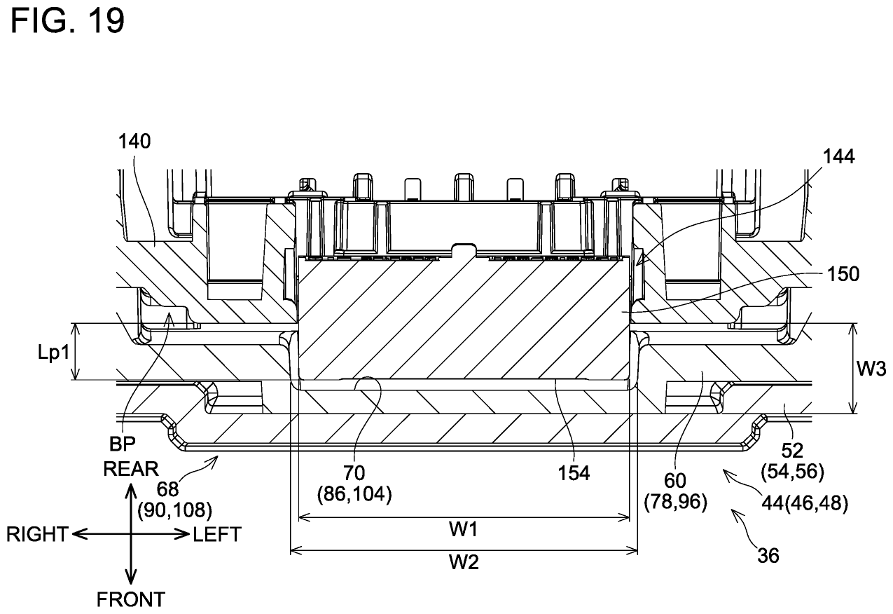

FIG. 19 is a horizontal cross-sectional view of the area including the relief groove 70, 86, or 104 of the battery attaching unit 36 of the embodiment.

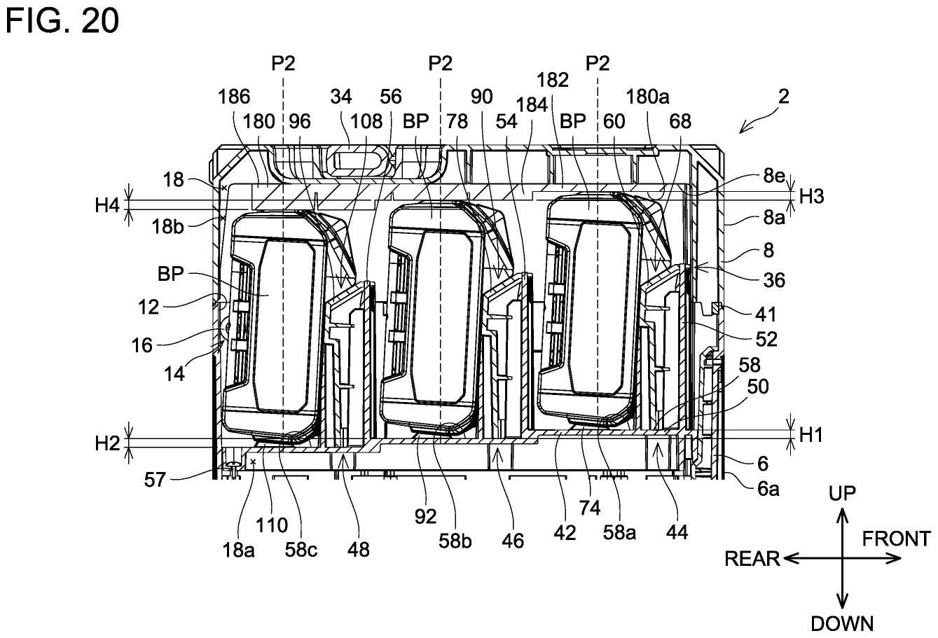

FIG. 20 is a cross-sectional view of the area including the battery attaching unit 36 when the case over 8 is in the closing position in the accommodating box 2 of the embodiment.

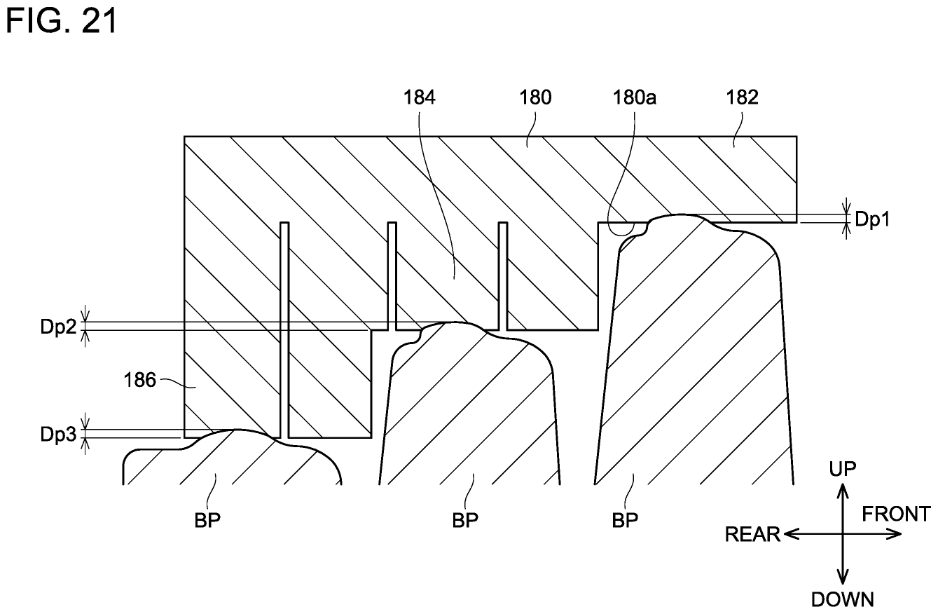

FIG. 21 is a cross-sectional view of a cushioning member 180 and the battery packs BP of the embodiment.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved accommodating boxes, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, when each of the battery packs is attached to the one of the battery attaching units, the holding member may be separated from the engagement member of the battery pack.

According to the above configuration, the engagement members of the battery packs can be suppressed from engaging with the holding members of the battery attaching units by a simple configuration.

In one or more embodiments, each of the battery packs may comprise a battery charge terminal member and a battery communication terminal member. The terminal member unit may comprise: a charge terminal member configured to be electrically connected to the battery charge terminal member of the battery pack when each of the battery packs is attached to the one of the battery attaching units; and a communication terminal member configured to be electrically connected to the battery communication terminal member of the battery pack when each of the battery packs is attached to the one of the battery attaching units. Each of the battery packs may be attached to the one of the battery attaching units by the battery pack moving in an attaching direction relative to the battery attaching unit. A length of the charge terminal member of the terminal member unit in the attaching direction may be 150% or less of a length of the communication terminal member of the terminal member unit in the attaching direction.

When the length of the charge terminal member of the terminal member unit in the attaching direction is greater than 150% of the length of the communication terminal member of the terminal member unit in the attaching direction, the battery packs cannot easily be attached to the battery attaching units due to a frictional force acting between the battery charge terminal members of the battery packs and the charge terminal members of the terminal member units. According to the above configuration, the battery packs can easily be attached to the battery attaching units.

In one or more embodiments, the charge terminal member of the terminal member unit may comprise: a linear part extending along the attaching direction; and an insertion part connected to an end of the linear part and tapering away from the linear part. When each of the battery packs moves in the attaching direction relative to the one of the battery attaching units, the insertion part may be inserted in the battery charge terminal member of the battery pack before the linear part is inserted in the battery charge terminal member. A length of the insertion part in the attaching direction may be 20% or more of the length of the charge terminal member in the attaching direction.

When the length of the insertion part in the attaching direction is less than 20% of the length of the charge terminal member in the attaching direction, the battery packs cannot easily be attached to the battery attaching units due to a frictional force acting between the battery charge terminal members of the battery packs and the insertion parts. According to the above configuration, the battery packs can easily be attached to the battery attaching units.

In one or more embodiments, the length of the charge terminal member of the terminal member unit in the attaching direction may be shorter than a length of the battery charge terminal member of each of the battery packs in the attaching direction. The battery charge terminal member of each of the battery packs may comprise: a first clamp part configured to clamp the charge terminal member; and a second clamp part configured to clamp the charge terminal member and disposed on an attaching position side in the attaching direction relative to the first clamp. The charge terminal member of the terminal member unit may be clamped by the second clamp part without passing through the first clamp part when each of the battery packs is attached to the one of the battery attaching units.

In a general battery pack, its battery charge terminal member is designed with a long length for high-speed charging. In a configuration in which high-speed charging of the battery packs is not necessary, the charge terminal member of the terminal member unit may be configured to contact only a part of the battery charge terminal member. When a configuring in which the charge terminal member of the terminal member unit to be clamped by the first clamp part is employed, when the battery pack is to be attached to the battery attaching unit, the charge terminal member is clamped by the second clamp part and passes therethrough, and is then clamped by the first clamp part. According to the aforementioned configuration, when each of the battery packs is to be attached to the one of the battery attaching units, the charge terminal member is clamped by the second clamp part without passing through the first clamp part. Due to this, the battery pack can easily be attached to the battery attaching unit as compared to the configuration in which the charge terminal member of the terminal member unit is clamped by the first clamp part.

In one or more embodiments, each of the battery packs may be positioned at an attaching position when the battery pack is attached to the one of the battery attaching units. The battery pack may move to the attaching position by its own weight when the battery pack is attached to the battery attaching unit.

According to the above configuration, the battery packs can easily be attached to the battery attaching units.

In one or more embodiments, the accommodating box may be configured to be placed on a placement surface. Each of the battery packs may be inclined relative to a perpendicular plane perpendicular to the placement surface when the accommodating box is placed on the placement surface and the battery pack is attached to the one of the battery attaching units.

According to the above configuration, the battery packs can easily be detached from the battery attaching units.

In one or more embodiments, the accommodating box may be configured to be placed on a placement surface. The case may have a box shape including an upper opening and accommodate at least a part of each of the plurality of battery attaching units. The plurality of battery attaching units may comprise: a first battery attaching unit; and a second battery attaching unit arranged away from the first battery attaching unit in a first direction which is along the placement surface. The battery packs may comprise a first battery pack and a second battery pack. The first battery pack may protrude toward an outside of the case from an inside of the case through the upper opening when the first battery pack is attached to the first battery attaching unit. The second battery pack may protrude toward the outside of the case from the inside of the case through the upper opening when the second battery pack is attached to the second battery attaching unit. A protruding length by which the first battery pack attached to the first battery attaching unit protrudes beyond the case may be longer than a protruding length by which the second battery pack attached to the second battery attaching unit protrudes beyond the case.

When the battery packs are protruding from the case, the user can easily grab the battery packs by hands. According to the above configuration, when the first battery pack is attached to the first battery attaching unit and the second battery pack is attached to the second battery attaching unit, the user can grab the first battery pack attached to the first battery attaching unit by hand and easily detach it therefrom.

In one or more embodiments, each of the first battery attaching unit and the second battery attaching unit may protrude toward the outside of the case from the inside of the case through the upper opening. A protruding length by which the first battery attaching unit protrudes beyond the case may be longer than a protruding length by which the second battery attaching unit protrudes beyond the case.

According to the above configuration, when the first battery pack is attached to the first battery attaching unit and the second battery pack is attached to the second battery attaching unit, the user can grab the first battery pack attached to the first battery attaching unit by hand and easily detach it therefrom.

In one or more embodiments, the accommodating box may comprise a case cover configured to close the upper opening of the case. The case cover may be attached to the case such that the case cover is movable relative to the case, and may be configured to move between a closing position in which the case cover closes the upper opening of the case and an opening position in which the case cover opens the upper opening of the case. The case cover may be disposed at a position away from the second battery attaching unit in the first direction when the case cover is in the opening position.

When the case cover is in the opening position, the user would stand on the opposite side from the case cover relative to the second battery attaching unit and attempt to detach the battery packs from the battery attaching units. According to the above configuration, when the first battery pack is attached to the first battery attaching unit and the second battery pack is attached to the second battery attaching unit, the first battery pack can more easily be detached from the first battery attaching unit.

In one or more embodiments, the accommodating box may comprise: a case cover configured to close the upper opening of the case; and a cushioning member attached to the case cover and constituted of an elastic material. When the case cover closes the upper opening of the case, the cushioning member may be clamped between the first battery pack attached to the first battery attaching unit and the case cover and may be clamped between the second battery pack attached to the second battery attaching unit and the case cover. A push-in depth by which the cushioning member is pushed by the first battery pack attached to the first battery attaching member may be substantially equal to a push-in depth by which the cushioning member is pushed by the second battery pack attached to the second battery attaching member.

According to the above configuration, a force that acts from the cushioning member on the first battery pack attached to the first battery attaching unit becomes substantially equal to a force that acts from the cushioning member on the second battery pack attached to the second battery attaching unit. Due to this, when the case cover is closing the upper opening of the case, the forces acting from the cushioning member on the plurality of battery packs can be made substantially equal and the plurality of battery packs can be kept at predetermined positions.

In one or more embodiments, the case may have a box shape including an upper opening. The accommodating box may comprise a case cover configured to close the upper opening of the case and defining an accommodating space between the case and the case cover when the upper opening of the case is closed. The plurality of battery attaching units may be disposed in the accommodating space. Each of the battery packs may be positioned at an attaching position when the battery pack is attached to the one of the battery attaching units. The case cover may keep each of the battery packs in the attaching position relative to the one of the battery attaching units when the upper opening of the case is closed.

According to the above configuration, when the case cover is closing the upper opening of the case, the battery packs can be suppressed from being displaced from their attaching positions relative to the battery attaching units.

In one or more embodiments, the accommodating box may comprise a cushioning member attached to the case cover and configured to be clamped between the battery packs and the case cover when the case cover closes the upper opening of the case. The cushioning member may be constituted of an elastic material.

Sizes of the battery packs may differ among the battery packs due to manufacturing tolerance. In a configuration in which the cushioning member does not elastically deform, an excessive force could be applied to specific battery pack(s) from the case cover when the case cover closes the upper opening of the case. According to the above configuration, even if the sizes of the battery packs differ among the battery packs, such application of the excessive force on the specific battery pack(s) from the case cover can be suppressed by elastic deformation of the cushioning member.

In one or more embodiments, the accommodating box may comprise: a detection device configured to detect that the upper opening of the case is closed by the case cover; and a control unit. The control unit may allow charging of the battery packs attached to the battery attaching units when the detection device detects that the upper opening of the case is closed by the case cover.

When the battery packs are displaced from the attaching positions, the battery packs cannot be charged correctly. According to the above configuration, since the battery packs are charged while being in the attaching positions, the battery packs can correctly be charged.

### Embodiment

As shown in FIGS. 1 and 2, an accommodating box 2 is a charger configured to simultaneously charge a plurality (twelve in this embodiment) of battery packs BP while accommodating them therein. As shown in FIG. 7, the accommodating box 2 is not electrically connected to a charging stage 4 by wiring, and is configured to charge the battery packs BP when it is placed on the charging stage 4 while accommodating the battery packs BP. The charging stage 4 is configured to operate on electric power supplied from an external power source (not shown) via a power cable (not shown). The accommodating box 2 may for example be a contactless electromagnetic induction charger. In a variant, the accommodating box 2 may be a contactless charger of a type other than electromagnetic induction. Hereinbelow, a direction perpendicular to a placement surface P1 on which the accommodating box 2 is placed will be termed an up-down direction, a longitudinal direction of the accommodating box 2 will be termed a left-right direction, and a direction perpendicular to the up-down direction and the left-right direction will be termed a front-rear direction.

As shown in FIGS. 1 and 2, the accommodating box 2 includes a case 6 and a case cover 8. The case 6 has a substantially rectangular box shape. The case 6 includes an upper opening 12 opened at its upper side. Further, the case 6 includes cover attachment parts 14 arranged near the left rear end and the right rear end. The case cover 8 is rotatably attached to the cover attachment parts 14 via attachment members 16. The case cover 8 is configured to move between a closing position and an opening position. As shown in FIG. 1, when the case cover 8 is in the closing position, the upper opening 12 of the case 6 (see FIG. 2) is closed. Due to this, an accommodating space 18 is thereby defined between the case 6 and the case cover 8 as shown in FIG. 7. The battery packs BP are arranged in the accommodating space 18. As shown in FIG. 2, when the case cover 8 is in the opening position, the upper opening 12 of the case 6 is opened. Due to this, a user can attach the battery packs BP to the accommodating box 2 from a front side of the case 6, and can also detach the battery packs BP from the accommodating box 2.

As shown in FIGS. 1 and 2, four cover locking members 20 are movably attached to portions near the upper end of the case 6. Two cover locking members 20 are attached to the vicinity of the left and right ends of a front surface 6a of the case 6, one cover locking member 20 is attached to the vicinity of the rear end of a left surface 6b of the case 6, and the remaining cover locking member 20 is attached to the vicinity of the rear end of a right surface 6c of the case 6.

The case cover 8 includes four cover engaging protrusions 22. Two cover engaging protrusions 22 are arranged at the vicinity of the left and right ends of a front surface 8a of the case cover 8, one cover engaging protrusion 22 is arranged at the vicinity of the rear end of the right surface 8c of the case cover 8. Although not shown, the remaining cover engaging protrusion 22 is arranged at the vicinity of the rear end of the left surface 8b of the case cover 8. When the case cover 8 is in the closing position, the cover engaging protrusions 22 engage with the cover locking members 20 by the user operating the cover locking members 20 to pull them upward. When the cover locking members 20 engage with the cover engaging protrusions 22, the user cannot move the case cover 8 from the opening position toward the closing position.

Further, four case engaging protrusions 24 are arranged at the vicinity of the lower end of the case 6. Two case engaging protrusions 24 are arranged at the vicinity of the left and right ends of the front surface 6a of the case 6, one case engaging protrusion 24 is arranged at the vicinity of the rear end of the left surface 6b of the case 6, and the remaining case engaging protrusion 24 is arranged at the vicinity of the rear end of the right surface 6c of the case 6. When the case cover 8 is in the closing position, the case engaging protrusions 24 align with the cover engaging protrusions 22 in the up-down direction.

Further, the case cover 8 has four case locking members 26 movably attached thereto. Two case locking members 26 are attached to the vicinity of the left and right ends of the front surface 8a of the case cover 8, one case locking member 26 is attached to the vicinity of the rear end the left surface 8b of the case cover 8, and the remaining case locking member 26 is attached to the vicinity of the rear end of the right surface 8c of the case cover 8. When the case cover 8 is in the closing position, the case locking members 26 are aligned with the cover locking members 20 in the up-down direction. The case 6 and the case cover 8 include vertical grooves 27 extending in the up-down direction, and the case locking members 26 and the cover locking members 20 are arranged in these vertical grooves 27 together with the cover engaging protrusions 22. As shown in FIG. 3, when the user operates the case locking members 26 to pull them upward in the state where a plurality (two in FIG. 3) of accommodating boxes 2 is stacked vertically, the case locking members 26 engage with the case engaging protrusions 24 (see FIG. 1). This can suppress falling of the plurality of accommodating boxes 2 stacked vertically.

Further, as shown in FIGS. 1 and 2, two lower finger hook grooves 28 are arranged at the vicinity of the lower end of the case 6. One of the lower finger hook grooves 28 is recessed from the left surface 6b of the case 6 and the other of the lower finger hook grooves 28 is recessed from the right surface 6c of the case 6. As shown in FIG. 4, each of the lower finger hook grooves 28 extends in the left-right direction from the left surface 6b (or the right surface 6c) of the case 6 toward inside of the case 6 and then bends and extends upward. For example, as shown in FIG. 5, when three accommodating boxes 2 are arranged in the front-rear direction, the user can easily pull out the accommodating box 2 at the center from between the other accommodating boxes 2 on both ends by inserting fingers in the lower finger hook groove(s) 28 of the accommodating box 2 at the center arranged between the other accommodating boxes 2 on its ends, placing the fingers on the case 6, and pulling out the accommodating box 2 at the center. In FIG. 5, the accommodating boxes 2 on both ends are depicted by broken lines.

Further, as shown in FIGS. 1 and 2, the case cover 8 has two belt attachment holes 30 defined therein. One of the belt attachment holes 30 is recessed from the left surface 8b of the case cover 8, and the other of the belt attachment holes 30 is recessed from the right surface 8c of the case cover 8. As shown in FIG. 6, each of the belt attachment holes 30 extends in the left-right direction from the left surface 8b (or the right surface 8c) of the case cover 8 toward inside of the case cover 8 and then bends and extends upward, reaching an upper surface 8d of the case cover 8. A shoulder belt 32 is inserted in the belt attachment holes 30. The shoulder belt 32 is attached to the case cover 8 by its one end being inserted into one of the belt attachment holes 30 and its other end being inserted into the other of the belt attachment holes 30. The user can easily carry the accommodating box 2 by putting the shoulder belt 32 on his/her shoulder. Further, the user can also carry the accommodating box 2 by inserting the fingers in the two belt attachment holes 30 and placing the fingers on the case cover 8. Further, as shown in FIG. 1, the case cover 8 has a handle 34 attached thereto, and the user can also carry the accommodating box 2 by gripping the handle 34. As such, the user can select the mode of carrying the accommodating box 2 according to situation.

As shown in FIG. 7, the accommodating box 2 further includes a battery attaching unit 36, a control unit 38, a power receiving unit 40, and a detection device 41. The battery attaching unit 36 is supported by the case 6. The battery packs BP are detachably attached to the battery attaching unit 36. As shown in FIG. 8, the battery attaching unit 36 includes a base 42, a front battery attaching unit 44, a center battery attaching unit 46, and a rear battery attaching unit 48.

As shown in FIG. 7, the base 42 is arranged inside the case 6. As shown in FIG. 8, the base 42 includes a base body 50, a front attachment member 52, a center attachment member 54, and a rear attachment member 56. The base body 50 has a shape of a wide plate. As shown in FIG. 7, the base body 50 is fixed to the case 6 by screws 57. A position of an upper surface 58 of the base body 50 in the up-down direction elevates like steps toward the front side. The upper surface 58 includes a front upper surface 58a, a center upper surface 58b, and a rear upper surface 58c. When the accommodating box 2 is placed on the placement surface P1, the front upper surface 58a, the center upper surface 58b, and the rear upper surface 58c are substantially parallel to the placement surface P1. A distance from the placement surface P1 is the shortest at the rear upper surface 58c and is the longest at the front upper surface 58a. A height H1 between the front upper surface 58a and the center upper surface 58b is substantially equal to a height H2 between the center upper surface 58b and the rear upper surface 58c. The heights H1, H2 may each for example be 3 mm or more, 5 mm or more, 10 mm or more, or 20 mm or more.

Further, the base body 50 separates the accommodating space 18 into a substrate accommodating space 18a and a battery accommodating space 18b. The control unit 38 and the power receiving unit 40 are arranged in the substrate accommodating space 18a. The control unit 38 is configured to control generation of induction and flux between the power receiving unit 40 and a power feeding unit (not shown) of the charging stage 4 when the accommodating box 2 is placed at a predetermined position on the charging stage 4. Since contactless electromagnetic induction charging configuration is well known, the explanation on the contactless charging configuration will be omitted hereinbelow. When the induction and flux are generated, current flows in the power receiving unit 40. The control unit 38 supplies the current flowing in the power receiving unit 40 to the battery packs BP attached to the battery attaching unit 36. Due to this, the battery packs BP are charged.

The detection device 41, the front attachment member 52, the center attachment member 54, the rear attachment member 56, the front battery attaching unit 44, the center battery attaching unit 46, and the rear battery attaching unit 48 are arranged in the battery accommodating space 18b. As shown in FIG. 2, inside the case 6, the detection device 41 is fixed at the vicinity of the upper opening 12 of the case 6. The detection device 41 is configured to detect that the upper opening 12 of the case 6 is closed by the case cover 8, that is, whether the case cover 8 is in the closing position. The detection device 41 may for example be a press-in switch. In this configuration, the detection device 41 detects that the case cover 8 is in the closing position when the detection device 41 is pressed in while the case cover 8 is in the closing position. In a variant, the detection device 41 may be a device other than a press-in switch, such as an optical sensor configured to detect whether its receiving light is interrupted. As shown in FIG. 7, the detection device 41 sends a signal to the control unit 38 while it is detecting that the case cover 8 is in the closing position. The control unit 38 allows charging of the battery packs BP while the signal is received from the detection device 41.

The front attachment member 52, the center attachment member 54, and the rear attachment member 56 are integrated with the base body 50. The front attachment member 52, the center attachment member 54, and the rear attachment member 56 are aligned along the front-rear direction. The front attachment member 52 extends from the vicinity of the front end of the base body 50 in a direction separating away from the base body 50 (upward). The center attachment member 54 extends from the vicinity of a portion of the base body connecting the front upper surface 58a and the center upper surface 58b in the direction separating away from the base body 50 (upward). The rear attachment member 56 extends from the vicinity of a portion of the base body 50 connecting the center upper surface 58b and the rear upper surface 58c in the direction separating away from the base body 50 (upward). When the accommodating box 2 is placed on the placement surface P1, the front attachment member 52, the center attachment member 54, and the rear attachment member 56 extend so as to be substantially perpendicular to the placement surface P1. As shown in FIG. 8, the front attachment member 52, the center attachment member 54, and the rear attachment member 56 each have a shape of a narrow plate extending in the left-right direction.

The front battery attaching unit 44 is fixed to the front attachment member 52 from the rear side. As shown in FIG. 9, the front battery attaching unit 44 is partially accommodated in the case 6. The front battery attaching unit 44 protrudes upward from the case 6 through the upper opening 12 of the case 6. A protruding length La1 of the front battery attaching unit 44 from the upper opening 12 may for example be 20 mm or more, 25 mm or more, or 30 mm or more. As shown in FIG. 8, the front battery attaching unit 44 includes a front holding member 60, a plurality of pairs (four pairs in this embodiment) of front rail units 62, a plurality (four in this embodiment) of front terminal member units 64, and a plurality of (four in this embodiment) front support members 66.

The front holding member 60, a pair of front rail units 62, one front terminal member unit 64, and one front support member 66 constitute a front battery attachment part 68. That is, the front battery attaching unit 44 includes a plurality (four in this embodiment) of front battery attachment parts 68. The four front battery attachment parts 68 are arranged along the left-right direction. The battery packs BP (see FIG. 2) are attached to the front battery attachment parts 68. When the plurality of battery packs BP is respectively attached to the front battery attachment parts 68, the plurality of battery packs BP aligns in the left-right direction. As shown in FIG. 9, when the battery packs BP are attached to the front battery attachment parts 68, the battery packs BP protrude upward from the case 6 through the upper opening 12 of the case 6. Due to this, the user can easily grab the battery packs BP by hands. A protruding length Lb1 of the battery packs BP from the upper opening 12 may for example be 50 mm or more, 55 mm or more, or 60 mm or more.

As shown in FIG. 8, the front holding member 60 faces the battery packs BP when the battery packs BP are attached to the front battery attachment parts 68. As shown in FIG. 10, a rear surface 60a of the front holding member 60 is inclined relative to a perpendicular plane P2 that is perpendicular to the front upper surface 58a of the base body 50, that is, it is inclined relative to the perpendicular plane P2 that is perpendicular to the placement surface P1 (see FIG. 9). An inclination angle thereof may for example be 2 degrees or less, 3 degrees or less, 5 degrees or less, or 10 degrees or less. Due to this, when the battery packs BP are attached to the front battery attachment parts 68, the battery packs BP are arranged to incline relative to the perpendicular plane P2. The battery packs BP inclining relative to the perpendicular plane P2 means that longitudinal axes of the battery packs BP incline relative to the perpendicular plane P2. Further, the perpendicular plane P2 extends along the up-down direction and the left-right direction. An inclination angle of the battery packs BP is substantially equal to the inclination angle of the rear surface 60a of the front holding member 60. Further, the battery packs BP are attached to the front battery attachment parts 68 by sliding the battery packs BP in an attaching direction D1 along the rear surface 60a of the front holding member 60, and the battery packs BP are detached from the front battery attachment parts 68 by sliding the battery packs BP in a detaching direction D2 opposite the attaching direction D1 along the rear surface 60a of the front holding member 60. The attaching direction D1 and the detaching direction D2 are inclined relative to the up-down direction. An inclination angle thereof is substantially equal to the inclination angle of the rear surface 60a of the front holding member 60.

As shown in FIG. 8, the four pairs of front rail units 62 are arranged along the left-right direction. Each pair of front rail units 62 protrudes rearward from the front holding member 60. Each pair of front rail units 62 extends in the up-down direction. Each pair of front rail units 62 is arranged away from each other in the left-right direction. Each pair of front rail units 62 includes a pair of front rail claws 72 protruding in directions approaching each other. Each pair of front rail claws 72 is arranged away from the front holding member 60 so as to be substantially parallel to the rear surface 60a of the front holding member 60. Each pair of front rail claws 72 extends substantially in the up-down direction. Each pair of front rail claws 72 is configured to engage with one of the battery packs BP. When one battery pack BP is engaged with one pair of front rail claws 72, the battery pack BP can slide in the attaching direction D1 (see FIG. 10) and in the detaching direction D2 (see FIG. 10) but cannot slide in the left-right direction or in the front-rear direction.

The front terminal member units 64 are held by the front holding member 60 by penetrating the front holding member 60. The front terminal member units 64 protrude rearward from the front holding member 60. In the left-right direction, each of the front terminal member units 64 is arranged between its corresponding pair of front rail units 62. The front terminal member units 64 are electrically connected to the control unit 38 (see FIG. 7). Detailed configurations of the front terminal member units 64 will be described later.

In the left-right direction, each of the front support members 66 is arranged between its corresponding pair of front rail units 62. The front support members 66 protrude rearward from the front holding member 60 and also protrude upward from the upper surface 58 of the base body 50. When the battery packs BP are attached to the front battery attachment parts 68, the front support members 66 come into contact with pairs of attachment rail units 142 of the battery packs BP (see FIG. 15) and support the battery packs BP.

The front holding member 60 includes a plurality (four in this embodiment) of front relief grooves 70. These four front relief grooves 70 are arranged along the left-right direction. In the left-right direction, each of the front relief grooves 70 is arranged between its corresponding pair of front rail units 62. Each of the front relief grooves 70 is arranged at an upper end of the rear surface 60a of the front holding member 60. The front relief grooves 70 are recessed frontward from the rear surface 60a. A depth of the front relief grooves 70 (width in the front-rear direction) becomes deeper toward the upper end of the front holding member 60. Upper ends of the front relief grooves 70 are open, that is, not closed.

As shown in FIG. 10, front support stages 74 are arranged behind the front support members 66. The front support stages 74 protrude upward from the upper surface 58 of the base body 50. When the battery packs BP are attached to the front battery attachment parts 68, the front support stages 74 come into contact with the lower surfaces of the battery packs BP and support the battery packs BP from below.

The center battery attaching unit 46 is fixed to the center attachment member 54 from the rear side. The center battery attaching unit 46 is arranged on the rear side of the front battery attaching unit 44. As shown in FIG. 9, the center battery attaching unit 46 is partially accommodated in the case 6. The center battery attaching unit 46 protrudes upward from the case 6 through the upper opening 12 of the case 6. A protruding length La2 by which the center battery attaching unit 46 protrudes from the case 6 is shorter than the protruding length La1 by which the front battery attaching unit 44 protrudes from the case 6. The protruding length La2 may for example be 15 mm or more, 20 mm or more, or 25 mm or more. Further, the protruding length La2 is shorter than the protruding length La1 by the height H1 (see FIG. 7). A difference between the protruding length La2 and the protruding length La1 may for example be 3 mm, 5 mm, 10 mm, or 20 mm.

As shown in FIG. 8, the center battery attaching unit 46 has the same configuration as the front battery attaching unit 44. The center battery attaching unit 46 includes a center holding member 78, a plurality of pairs (four pairs in this embodiment) of center rail units 80, a plurality (four in this embodiment) of center terminal member units 82, and a plurality (four in this embodiment) of center support members 84. The center holding member 78 has the same configuration as the front holding member 60, the pairs of center rail units 80 have the same configuration as the pairs of front rail units 62, the center terminal member units 82 have the same configuration as the front terminal member units 64, and the center support members 84 have the same configuration as the front support members 66. Further, center relief grooves 86 defined in the center holding member 78 have the same configuration as the front relief grooves 70 defined in the front holding member 60. Further, pairs of center rail claws 88 of the pairs of center rail units 80 have the same configuration as the pairs of front rail claws 72 of the pairs of front rail units 62.

The center holding member 78, a pair of center rail units 80, one center terminal member unit 82, and one center support member 84 constitute a center battery attachment part 90. That is, the center battery attaching unit 46 includes a plurality (four in this embodiment) of center battery attachment parts 90. The four center battery attachment parts 90 are arranged along the left-right direction. The battery packs BP (see FIG. 2) are detachably attached to the center battery attachment parts 90. When the plurality of battery packs BP is attached to the center battery attachment parts 90, the plurality of battery packs BP aligns in the left-right direction. As shown in FIG. 9, when the battery packs BP are attached to the center battery attachment parts 90, the battery packs BP protrude upward from the case 6 through the upper opening 12 of the case 6. Due to this, the user can easily grab the battery packs BP by hands. A protruding length Lb2 by which the battery packs BP attached to the center battery attachment parts 90 protrude from the case 6 is shorter than the protruding length Lb1 by which the battery packs BP attached to the front battery attachment parts 68 protrude from the case 6. The protruding length Lb2 may for example be 45 mm or more, 50 mm or more, or 55 mm or more. Further, the protruding length Lb2 is shorter than the protruding length Lb1 by the height H1 (see FIG. 7). A difference between the protruding length Lb2 and the protruding length Lb1 may for example be 3 mm, 5 mm, 10 mm, or 20 mm. Further, when the battery packs BP are attached to the center battery attachment parts 90, the battery packs BP are inclined relative to the perpendicular plane P2. An inclination angle of the battery packs BP is substantially equal to the inclination angle of the rear surface of the center holding member 78.

As shown in FIG. 10, center support stages 92 are arranged behind the center support members 84. The center support stages 92 protrude upward from the upper surface 58 of the base body 50. When the battery packs BP are attached to the center battery attachment parts 90, the center support stages 92 come into contact with the lower surfaces of the battery packs BP and support the battery packs BP from below.

The rear battery attaching unit 48 is fixed to the rear attachment member 56 from the rear side. The rear battery attaching unit 48 is arranged on the rear side of the center battery attaching unit 46. Due to this, the front battery attaching unit 44, the center battery attaching unit 46, and the rear battery attaching unit 48 are aligned along the front-rear direction. The front-rear direction is substantially equal to a direction along which the front battery attaching unit 44, the center battery attaching unit 46, and the rear battery attaching unit 48 align. As shown in FIG. 11, the rear battery attaching unit 48 is arranged on the front side of the cover attachment parts 14 of the case 6. The rear battery attaching unit 48 is arranged on the front side of the case cover 8 when the case cover 8 is in the closing position. As shown in FIG. 9, the rear battery attaching unit 48 is partially accommodated in the case 6. The rear battery attaching unit 48 protrude upward from the case 6 through the upper opening 12 of the case 6. A protruding length La3 by which the rear battery attaching unit 48 protrude from the case 6 is shorter than the protruding length La2 by which the center battery attaching unit 46 protrudes from the case 6. The protruding length La3 may for example be 10 mm or more, 15 mm or more, or 20 mm or more. Further, the protruding length La3 is shorter than the protruding length La2 by the height H2 (see FIG. 7). A difference between the protruding length La3 and the protruding length La2 may for example be 3 mm, 5 mm, 10 mm, or 20 mm. Further, the protruding lengths by which the battery attaching units protrude from the case 6 decrease in the order of the front battery attaching unit 44, the center battery attaching unit 46, and the rear battery attaching unit 48.

As shown in FIG. 8, the rear battery attaching unit 48 has the same configuration as the front battery attaching unit 44. The rear battery attaching unit 48 includes a rear holding member 96, a plurality of pairs (four pairs in this embodiment) of rear rail units 98, a plurality (four in this embodiment) of rear terminal member units 100, and a plurality (four in this embodiment) of rear support members 102. The rear holding member 96 has the same configuration as the front holding member 60, the pairs of rear rail units 98 have the same configuration as the pairs of front rail units 62, the rear terminal member units 100 have the same configuration as the front terminal member units 64, and the rear support members 102 have the same configuration as the front support members 66. Further, rear relief grooves 104 defined in the rear holding member 96 have the same configuration as the front relief grooves 70 defined in the front holding member 60. Further, pairs of rear rail claws 106 of the pairs of rear rail units 98 have the same configuration as the pairs of front rail claws 72 of the pairs of front rail units 62.

The rear holding member 96, a pair of rear rail units 98, one rear terminal member unit 100, and one rear support member 102 constitute a rear battery attachment part 108. That is, the rear battery attaching unit 48 includes a plurality (four in this embodiment) of rear battery attachment parts 108. The four rear battery attachment parts 108 are arranged along the left-right direction. The battery packs BP (see FIG. 2) are detachably attached to the rear battery attachment parts 108. When the plurality of battery packs BP is attached to the rear battery attachment parts 108, the plurality of battery packs BP aligns in the left-right direction. As shown in FIG. 9, when the battery packs BP are attached to the rear battery attachment parts 108, the battery packs BP protrude upward from the case 6 through the upper opening 12 of the case 6. Due to this, the user can easily grab the battery packs BP by hands. A protruding length Lb3 by which the battery packs BP attached to the rear battery attachment parts 108 protrude from the case 6 is shorter than the protruding length Lb2 by which the battery packs BP attached to the center battery attachment parts 90 protrude from the case 6. The protruding length Lb3 may for example be 40 mm or more, 45 mm or more, or 50 mm or more. Further, the protruding length Lb3 is shorter than the protruding length Lb2 by the height H2 (see FIG. 7). A difference between the protruding length Lb3 and the protruding length Lb2 may for example be 3 mm, 5 mm, 10 mm, or 20 mm. Further, the protruding lengths by which the battery packs BP protrude from the case 6 decreases in the order of the battery packs BP attached to the front battery attaching unit 44, the battery packs BP attached to the center battery attaching unit 46, and the battery packs BP attached to the rear battery attaching unit 48. Due to this, the user stands in front of the accommodating box 2 (the opposite side from the case cover 8 (see FIG. 11) relative to the battery attaching unit 36) and firstly takes out the battery packs BP attached to the front battery attaching unit 44, then takes out the battery packs BP attached to the center battery attaching unit 46, and in the end takes out battery packs BP attached to the rear battery attaching unit 48, by which the user can easily take out the battery packs BP from the accommodating box 2. Further, when the battery packs BP are attached to the rear battery attachment parts 108, the battery packs BP are inclined relative to the perpendicular plane P2. An inclination angle of the battery packs BP is substantially equal to the inclination angle of the rear surface of the rear holding member 96.

As shown in FIG. 10, rear support stages 110 are arranged behind the rear support members 102. The rear support stages 110 protrude upward from the upper surface 58 of the base body 50. When the battery packs BP are attached to the rear battery attachment parts 108, the rear support stages 110 come into contact with the lower surfaces of the battery packs BP and support the battery packs BP from below.

Detailed configurations of the front terminal member units 64, the center terminal member units 82, and the rear terminal member units 100 will be described. Since the configurations of the front terminal member units 64, the center terminal member units 82, and the rear terminal member units 100 are the same, one rear terminal member unit 100 will be taken as an example and explained below. As shown in FIG. 12, the rear terminal member unit 100 includes a plurality (two in this embodiment) of metal charge terminal members 120 and a plurality (four in this embodiment) of metal communication terminal members 122.

The charge terminal members 120 and the communication terminal members 122 are directly fixed to the rear holding member 96 by insert molding. The charge terminal members 120 and the communication terminal members 122 protrude rearward from the rear holding member 96. A length by which the charge terminal members 120 protrude from the rear holding member 96 is substantially equal to a length by which the communication terminal members 122 protrude from the rear holding member 96. In the up-down direction, the charge terminal members 120 and the communication terminal members 122 are arranged between the rear relief groove 104 and the rear support member 102.

The charge terminal members 120 are terminals for passing charging current to the battery pack BP (see FIG. 2). The two charge terminal members 120 are aligned along the left-right direction. The communication terminal members 122 are terminals for communication between the control unit 38 (see FIG. 7) and the battery pack BP. In the left-right direction, the four communication terminal members 122 are arranged between the two charge terminal members 120. The four communication terminal members 122 include two upper communication terminal members 124 aligned along the left-right direction and two lower communication terminal members 126 aligned along the left-right direction. The upper communication terminal members 124 are aligned with the lower communication terminal members 126 in the up-down direction. The two lower communication terminal members 126 are aligned with the two charge terminal members 120 in the left-right direction.

As shown in FIG. 13, each charge terminal member 120 includes a linear part 130 and an insertion part 132. The linear part 130 and the insertion part 132 are exposed to the outside of the rear holding member 96. The linear part 130 extends along the attaching direction D1. A width of the linear part 130 in the left-right direction is constant along the attaching direction D1. The insertion part 132 is connected to one end of the linear part 130. A width of the insertion part 132 in the left-right direction tapers away from the linear part 130. A length Lt1 of the insertion part 132 in the attaching direction D1 may for example be 100% or less, 90% or less, 80% or less, 70% or less, or 65% or less of a length Lt2 of the linear part 130 in the attaching direction D1. Further, the length Lt1 may for example be 20% or more, 25% or more, 30% or more, or 35% or more of the length Lt2. Further, the length Lt1 may for example be 55% or less, 50% or less, 45% or less, or 40% or less of a length Lt3 of the charge terminal member 120 in the attaching direction D1. Further, the length Lt1 may for example be 20% or more, 25% or more, 30% or more, or 35% or more of the length Lt3.

Further, the length Lt3 of the charge terminal member 120 is 100% or more of a length Lt4 of the lower communication terminal member 126 in the attaching direction D1. The length Lt4 is a length of portions of the lower communication terminal member 126 exposed from the rear holding member 96. Further, the length Lt3 may for example be 150% or less, 140% or less, 130% or less, or 125% or less of the length Lt4. Further, the length Lt4 of the lower communication terminal member 126 is substantially equal to a length Lt5 of the upper communication terminal member 124 in the attaching direction D1. The length Lt5 is a length of portions of the upper communication terminal member 124 exposed from the rear holding member 96.

The upper communication terminal member 124 has the same shape as the lower communication terminal member 126. Each of the upper communication terminal members 124 includes a base part 134 and an insertion part 136. The base part 134 and the insertion part 136 are exposed to the outside of the rear holding member 96. The base part 134 extends along the attaching direction D1. The insertion part 136 is connected to one end of the base part 134. A width of the insertion part 136 in the left-right direction tapers away from the base part 134. A length Lt6 of the insertion part 136 in the attaching direction D1 is 40% or less, 35% or less, 30% or less, 25% or less, or 20% or less of the length Lt5 of the upper communication terminal member 124. The length Lt6 is 5% or more, 10% or more, or 15% or more of the length Lt5. Further, the length Lt6 is shorter than the length Lt1 of the insertion part 132 of the charge terminal member 120. A taper angle of the insertion part 136 of the upper communication terminal member 124 is larger than a taper angle of the insertion part 132 of the charge terminal member 120.

Next, the battery pack BP shown in FIG. 14 will be described. The battery pack BP is used by being attached to a battery attachment part 202 of an electrical device 200. In FIG. 14, the electrical device 200 is depicted by a broken line. The electrical device 200 may be an electrical device that operates on power supplied from battery pack(s) BP. The electrical device 200 may for example be a power tool such as a driver or a drill that uses a motor as its prime mover, or may be a power working machine such as a mower or a blower that uses a motor as its prime mover. Alternatively, the electrical device 200 may be an electrical device not including a motor, such as a light, radio, and a speaker. Alternatively, the electrical device 200 may be a charger that supplies electric power to battery pack(s) BP. The battery pack BP may for example have a rated voltage of 36V, a maximum voltage of 40V, and a rated capacity of 2.5 Ah. Further, the battery pack BP may have a rated voltage of 36V, a maximum voltage of 40V, and a rated capacity of 4.0 Ah. Further, the battery packs BP may have a rated voltage of 36V, a maximum voltage of 40V, and a rated capacity of 5.0 Ah. Further, the battery pack BP may have a rated voltage of 36V, a maximum voltage of 40V, and a rated capacity of 8.0 Ah. Weight of the battery pack BP may for example be 2 kg or less.

As shown in FIG. 15, the battery pack BP includes a casing 140, a pair of attachment rail units 142, a hook 144, and a battery terminal member unit 146 (see FIG. 16). The casing 140 accommodates secondary batteries, such as lithium-ion batteries therein.

The pair of attachment rail units 142 protrudes from the front surface of the casing 140. The pair of attachment rail units 142 extends substantially in the up-down direction along the front surface of the casing 140. The pair of attachment rail units 142 includes a pair of attachment rail claws 148 that protrudes in directions separating away from each other. The pair of attachment rail claws 148 extends substantially in the up-down direction along the front surface of the casing 140. When the battery pack BP is attached to the battery attaching unit 36 (see FIG. 8), the pair of attachment rail claws 148 engages with the pair of front rail claws 72 (see FIG. 8), the pair of center rail claws 88 (see FIG. 8), or the pair of rear rail claws 106 (see FIG. 8) of the accommodating box 2. Further, a pair of device rail claws (not shown) extending in the battery attaching direction is arranged at the battery attachment part 202 of the electrical device 200 (see FIG. 14), and when the battery pack BP is attached to the battery attachment part 202, the pair of attachment rail claws 148 engages with the pair of device rail claws. When the battery pack BP is slid in a battery attaching direction relative to the battery attachment part 202, the pair of attachment rail claws 148 engages with the pair of device rail claws, by which the battery pack BP is attached to the battery attachment part 202. When the pair of attachment rail claws 148 engages with the pair of device rail claws, the battery pack BP can slide relative to the battery attachment part 202 only in the battery attaching direction and in a battery detaching direction which is opposite the battery attaching direction, but it cannot slide in directions other than the battery attaching direction and the battery detaching direction, such as in a direction perpendicular to the battery attaching direction. Further, when the battery pack BP attached to the battery attachment part 202 is slid in the battery detaching direction relative to the battery attachment part 202, the pair of attachment rail claws 148 is released from the pair of device rail claws, by which the battery pack BP is detached from the battery attachment part 202.

The hook 144 is movably attached to the casing 140. The hook 144 includes an engagement part 150 and an operation part 152. The engagement part 150 is arranged between the pair of attachment rail units 142. The engagement part 150 may for example be an engagement claw. As shown in FIG. 14, the battery attachment part 202 of the electrical device 200 includes an engagement recess 204, and the engagement part 150 is configured to engage with the engagement recess 204. The engagement part 150 normally protrudes to the outside of the casing 140. The engagement part 150 is configured to move into the casing 140. Further, the engagement part 150 includes a guide part 154 inclined at an acute angle relative to the front surface of the casing 140. As shown in FIG. 15, the operation part 152 is integrated with the engagement part 150. The operation part 152 is attached to the casing 140 such that the operation part 152 can be pressed into the casing 140. When the operation part 152 is operated by the user and is pressed into the casing 140, an entirety of the engagement part 150 moves into the casing 140. When the operation on the operation part 152 is released in the state where the operation part 152 is pressed into the casing 140, the operation part 152 returns to its initial position by a biasing force applied by a biasing spring (not shown). Due to this, the engagement part 150 returns to its initial state of protruding to the outside of the casing 140.

Movement of the hook 144 when the battery pack BP is to be attached to the battery attachment part 202 or detached therefrom will be described. As shown in FIG. 14, when the battery pack BP is slid in the battery attaching direction relative to the battery attachment part 202, the engagement part 150 is gradually pressed into the casing 140 by the guide part 154 coming into contact with the battery attachment part 202. When the engagement part 150 reaches the engagement recess 204, the guide part 154 is no longer in contact with the battery attachment part 202, thus the engagement part 150 returns to the initial state by the biasing force of the biasing spring (not shown) and engages with the engagement recess 204. In the state where the engagement part 150 is engaged with the engagement recess 204, the battery pack BP cannot be slid in the battery detaching direction relative to the battery attachment part 202, that is, the battery pack BP cannot be detached from the battery attachment part 202.

When the battery pack BP is to be detached from the battery attachment part 202, the operation part 152 shown in FIG. 15 is pressed into the casing 140 by the user. Due to this, the engagement part 150 moves into the casing 140 and the engagement between the engagement part 150 and the engagement recess 204 is released. When the battery pack BP is slid in the battery detaching direction relative to the battery attachment part 202 with the operation part 152 pressed into the casing 140, the pair of attachment rail claws 148 is released from the pair of device rail claws of the battery attachment part 202, and the battery pack BP is thereby detached from the battery attachment part 202.

The battery terminal member unit 146 will be described. As shown in FIG. 15, a plurality of terminal grooves 156 is arranged between the pair of attachment rail claws 148, and the battery terminal member unit 146 (see FIG. 16) is arranged inside the terminal grooves 156. The battery terminal member unit 146 shown in FIG. 16 is arranged inside the casing 140 (see FIG. 15). The battery terminal member unit 146 includes a plurality (two in this embodiment) of metal battery charge terminal members 160 and a plurality (four in this embodiment) of metal battery communication terminal members 162.

The battery charge terminal members 160 each include four charging clamp parts 164. The four charging clamp parts 164 are aligned in a line. The four charging clamp parts 164 are integrated. Each of the battery charge terminal members 160 is configured to electrically connect to another terminal member by at least one of the four charging clamp parts 164 clamping the other terminal member. Hereinbelow, two charging clamp parts 164 arranged on the upper side among the four charging clamp parts 164 may be termed upper charging clamp parts 166, and two charging clamp parts 164 arranged on the lower side among the four charging clamp parts 164 may be termed lower charging clamp parts 168. The lower charging clamp parts 168 are disposed on the attaching position side in the attaching direction D1 relative to the upper charging clamp parts 166.

The battery communication terminal members 162 are each configured to electrically connect to another terminal member by clamping the other terminal member. The four battery communication terminal members 162 include two upper battery communication terminal members 172 arranged to align along the left-right direction and two lower battery communication terminal members 174 arranged to align along the left-right direction. The two upper battery communication terminal members 172 are arranged between the upper charging clamp parts 166 of one of the battery charge terminal members 160 and the upper charging clamp parts 166 of the other of the battery charge terminal members 160. The two lower battery communication terminal members 174 are arranged between the lower charging clamp parts 168 of one of the battery charge terminal members 160 and the lower charging clamp parts 168 of the other of the battery charge terminal members 160.

A procedure for attaching the battery pack BP to the front battery attachment part 68 (or center battery attachment part 90 or rear battery attachment parts 108) (see FIG. 8) will be described. Firstly, the battery pack BP (see FIG. 15) is positioned above the front holding member 60 (or center holding member 78 or rear holding member 96) (see FIG. 8), and is slid in the attaching direction D1 (see FIG. 12) along the front holding member 60 (or center holding member 78 or rear holding member 96) by the battery pack BP's own weight. The charge terminal members 120 of the front battery attachment part 68 (or center battery attachment parts 90 or rear battery attachment parts 108) shown in FIG. 17 art inserted into the lower charging clamp parts 168 from below the lower charging clamp parts 168 of the battery pack BP. At this occasion, the insertion parts 132 of the charge terminal member 120 are inserted into the lower charging clamp parts 168, and then the linear parts 130 of the charge terminal members 120 are inserted into the lower charging clamp parts 168. Since the taper angle of the insertion parts 132 is smaller than the taper angle of the insertion part 136 of the communication terminal members 124 (see FIG. 13), the insertion parts 132 can easily be inserted into the lower charging clamp parts 168 than the insertion parts 136 would be. In FIG. 17, a boundary between the linear part 130 and the insertion part 132 is indicated by a broken line. When the insertion parts 132 pass through the lowermost charging clamp parts 164 and slightly inserted into the charging clamp parts 164 arranged second from the bottom, the battery pack BP reaches an attaching position. At this occasion, the charge terminal members 120 is electrically connected to the battery charge terminal members 160. In this embodiment, each charge terminal member 120 is only inserted fully into one charging clamp part 164 and a part of another charging clamp part 164, thus the battery pack BP moves to the attaching position by its own weight. As shown in FIG. 11, when the battery pack BP reaches the attaching position, the lower end of the battery pack BP comes into contact with the front support stage 74 (or center support stage 92 or rear support stage 110), and the pair of attachment rail units 142 of the battery pack BP (see FIG. 15) comes into contact with the front support member 66 (or center support member 84 or rear support members 102) (see FIG. 10). Due to this, the battery pack BP cannot be slid further in the attaching direction D1. As a result, as shown in FIG. 17, the charge terminal members 120 do not pass through the upper charging clamp parts 166 upon attaching the battery pack BP.

Further, when the battery pack BP is at the attaching position, each of the charge terminal members 120 is clamped only by the lower charging clamp parts 168 (two charging clamp parts 164). In a configuration in which the charge terminal members 120 are longer than the charge terminal members 120 of the present embodiment and thus are clamped by the four charging clamp parts 164, the battery pack BP is charged at high speed. On the other hand, in a configuration in which the charge terminal members 120 are clamped only by two charging clamp parts 164 as in the present embodiment, the battery pack BP is charged over a long period of time (such as in 8 hours). Due to this, for example, by starting charging of the battery pack BP in the evening of the day before using the battery pack BP, the battery pack BP is fully charged by the morning of the day when the battery pack BP is used, and the battery pack BP can be charged efficiently.

Further, although not shown, the upper communication terminal members 124 (see FIG. 12) of each of the front battery attachment parts 68 (or center battery attachment parts 90 or rear battery attachment parts 108) are inserted into the lower battery communication terminal members 174 shown in FIG. 16 from their insertion parts 136 (see FIG. 13). Then, the upper communication terminal members 124 moves past the lower battery communication terminal members 174 and are inserted into the upper battery communication terminal members 172. When the upper communication terminal members 124 are inserted into the upper battery communication terminal members 172, the battery pack BP reaches the attaching position. At this occasion, the upper communication terminal members 124 are electrically connected to the upper battery communication terminal members 172. Further, although not shown, the lower communication terminal members 126 (see FIG. 12) of each of the front battery attachment parts 68 (or center battery attachment parts 90 or rear battery attachment parts 108) are inserted into the lower battery communication terminal members 174. When the lower communication terminal members 126 are inserted into the lower battery communication terminal members 174, the battery pack BP reaches the attaching position. At this occasion, the lower communication terminal members 126 are electrically connected to the lower battery communication terminal members 174.

Further, when the battery pack BP is slid in the attaching direction D1, the engagement part 150 of the battery pack BP shown in FIGS. 18 and 19 enters into the front relief groove 70 (or center relief groove 86 or rear relief groove 104) from above. When the battery pack BP reaches the attaching position, the engagement part 150 is arranged in the front relief groove 70 (or center relief groove 86 or rear relief groove 104). Since the shapes of the front relief groove 70, the center relief groove 86, and the rear relief groove 104 are the same, the relationship between the engagement part 150 and the front relief groove 70 is taken as an example and explained.

A width W1 of the engagement part 150 in the left-right direction is shorter than a width W2 of the front relief groove 70 in the left-right direction. Due to this, in the left-right direction, the engagement part 150 is arranged within the front relief groove 70 while being separated from the front holding member 60. Further, when the engagement part 150 is in its initial position, a protruding length Lp1 by which the engagement part 150 protrudes from the casing 140 is shorter than a width W3 between the casing 140 and the front holding member 60 in the front relief groove 70. Due to this, in the front-rear direction, the engagement part 150 is separated from the front holding member 60 in the state where the guide part 154 faces the front holding member 60 in the front relief groove 70. Further, in the up-down direction, the engagement part 150 is separated from the front holding member 60 in the front relief groove 70. Further, the front battery attachment part 68 is arranged at a position which overlaps the engagement part 150 in the up-down direction (or attaching direction D1) but is not beyond the engagement part 150 in the detaching direction D2. As such, the engagement part 150 does not contact the front holding member 60 nor in engagement with the front holding member 60. Due to this, the battery pack BP is attached to the front battery attachment part 68 (or center battery attachment part 90 or rear battery attachment part 108) without engagement of the engagement part 150. Further, when the battery pack BP is to be attached to the front battery attachment part 68 (or center battery attachment part 90 or rear battery attachment part 108), the guide part 154 of the engagement part 150 does not contact the front holding member 60, thus the engagement part 150 is not pressed into the casing 140.

When the battery pack BP reaches the attaching position, that is, when the battery pack BP is attached to the front battery attachment part 68 (or center battery attachment part 90 or rear battery attachment part 108), the battery pack BP can then be charged. Upon charging the battery pack BP, the battery pack BP needs to be kept at the attaching position. Due to this, as shown in FIG. 20, the accommodating box 2 further includes a cushioning member 180. The cushioning member 180 is constituted of an elastic material such as a rubber material. The cushioning member 180 has a substantially flat plate shape. The cushioning member 180 is attached to an inner upper surface 8e of the case cover 8. When the case cover 8 is in the closing position, the cushioning member 180 is clamped between the battery pack BP and the case cover 8. Due to this, the battery pack BP is kept at the attaching position by the case cover 8 and the cushioning member 180. When the battery pack BP is in the attaching position, a contact surface 180a of the cushioning member 180 contacts the battery pack BP. The contact surface 180a is a surface on an opposite side from a surface of the cushioning member 180 attached to the case cover 8.

The cushioning member 180 includes a front contact part 182, a center contact part 184, and a rear contact part 186. When the case cover 8 is in the closing position, the front contact part 182, the center contact part 184, and the rear contact part 186 are aligned along the front-rear direction. When the case cover 8 is in the closing position, the front contact part 182 is arranged at a position facing the battery packs BP attached to the front battery attaching unit 44, the center contact part 184 is arranged at a position facing the battery packs BP attached to the center battery attaching unit 46, and the rear contact part 186 is arranged at a position facing the battery packs BP attached to the rear battery attaching unit 48. When the case cover 8 is in the closing position, the front contact part 182 is clamped between the battery packs BP attached to the front battery attaching unit 44 and the case cover 8, the center contact part 184 is clamped between the battery packs BP attached to the center battery attaching unit 46 and the case cover 8, and the rear contact part 186 is clamped between the battery packs BP attached to the rear battery attaching unit 48 and the case cover 8.

A thickness of the cushioning member 180 (width between the contact surface 180a and the inner upper surface 8e of the case cover 8) is the thinnest at the front contact part 182 and is the thickest at the rear contact part 186. Further, when the case cover 8 is in the closing position, the contact surface 180a is arranged at its highest position at the front contact part 182 and is arranged at its lowest position at the rear contact part 186. A height H3 between the contact surface 180a at the front contact part 182 and the contact surface 180a at the center contact part 184 is substantially equal to a height H4 between the contact surface 180a at the center contact part 184 and the contact surface 180a at the rear contact part 186. Further, the height H3 is substantially equal to the height H1 between the front upper surface 58a and the center upper surface 58b of the base body 50. The height H4 is substantially equal to the height H2 between the center upper surface 58b and the rear upper surface 58c of the base body 50.

When the case cover 8 is in the closing position, the cushioning member 180 is pushed against the battery packs BP. As shown in FIG. 21, the cushioning member 180 is pushed onto the battery packs BP by elastic deformation. In FIG. 21, the thickness of the cushioning member 180 and the length of the battery packs BP in the up-down direction are depicted with emphasis. A push-in depth Dp1 by which the front contact part 182 is pushed in by the battery packs BP is substantially equal to each of a push-in depth Dp2 by which the center contact part 184 is pushed in by the battery packs BP and a push-in depth Dp3 by which the rear contact part 186 is pushed in by the battery packs BP. Due to this, the plurality of battery packs BP is pushed in to reach the attaching positions by a uniform force applied by the cushioning member 180.

(Effects)

The accommodating box 2 of the present embodiment is configured to charge the battery packs BP in the state in which the battery packs BP are accommodated in the accommodating box 2, the battery packs BP configured to be used by being attached to the electrical device 200. The accommodating box 2 comprises the case 6 and the plurality of battery attaching units 36 supported by the case 6. Each of the battery packs BP is configured to be attached to one of the plurality of the battery attaching units 36. Each of the battery packs BP comprises the hook 144 (an example of engagement member) configured to engage with the electrical device 200 when the battery pack BP is attached to the electrical device 200, and the engagement between the battery pack BP and the electrical device 200 is released by the user's operation on the hook 144. The battery attaching units 36 comprise: the terminal member units 64, 82, 100 each configured to be electrically connected to one of the battery packs BP when the battery pack BP is attached to the battery attaching unit 36 and the holding members 60, 78, 96 that respectively holds the terminal member units 64, 82, 100. Each of the holding members 60, 78, 96 is not engaged with the hook 144 of the one of the battery packs BP when the battery pack BP is attached to the battery attaching unit 36.

According to the above configuration, when the battery packs BP are attached to the battery attaching units 36, the hooks 144 of the battery packs BP do not engage with the holding members 60, 78, 96 of the battery attaching units 36. Due to this, when the battery packs BP are to be detached from the battery attaching units 36, work for releasing the engagement of the hooks 144 and the holding members 60, 78, 96 becomes unnecessary. Thus, the battery packs BP can easily be detached from the battery attaching units 36.

Further, when the battery packs BP are attached to the battery attaching units 36, the holding members 60, 78, 96 are separated from the hooks 144 of the battery packs BP.

According to the above configuration, the hooks 144 of the battery packs BP can be suppressed from engaging with the holding members 60, 78, 96 of the battery attaching units 36 by a simple configuration.

Further, each of the battery packs BP comprises the battery charge terminal members 160 and the battery communication terminal members 162. Each of the terminal member units 64, 82, 100 comprises the charge terminal members 120 configured to be electrically connected to the battery charge terminal members 160 of the battery pack BP when each of the battery packs BP is attached to the one of the battery attaching units 36; and the communication terminal members 122 configured to be electrically connected to the battery communication terminal members 162 of the battery pack BP when each of the battery packs BP is attached to the one of the battery attaching units 36. Each of the battery packs BP is attached to the one of the battery attaching units 36 by the battery pack BP moving in the attaching direction D1 relative to the battery attaching unit 36. The length Lt3 of each of the charge terminal members 120 of the terminal member units 64, 82, 100 in the attaching direction D1 is 150% or less of the lengths Lt4, Lt5 of the communication terminal members 122 of the terminal member units 64, 82, 100 in the attaching direction D1.

When the length Lt3 of each of the charge terminal members 120 of the terminal member units 64, 82, 100 in the attaching direction D1 is 150% or more of the lengths Lt4, Lt5 of the communication terminal members 122 of the terminal member units 64, 82, 100 in the attaching direction D1, the battery packs BP cannot easily be attached to the battery attaching units 36 due to the frictional force acting between the battery charge terminal members 160 of the battery packs BP and the charge terminal members 120 of the terminal member units 64, 82, 100. According to the above configuration, the battery packs BP can easily be attached to the battery attaching units 36.

Further, the charge terminal members 120 of the terminal member units 64, 82, 100 each comprise: the linear part 130 extending along the attaching direction D1 and the insertion part 132 connected to one end of the linear part 130 and tapering away from the linear part 130. When each of the battery packs BP moves in the attaching direction D1 relative to the one of the battery attaching units 36, the insertion part 132 is inserted in a corresponding one of the battery charge terminal members 160 of the battery pack BP before the linear part 130 is inserted therein. The length Lt1 of the insertion part 132 in the attaching direction D1 is 20% or more of the length Lt3 of the charge terminal member 120 in the attaching direction D1.

When the length Lt1 of the insertion part 132 in the attaching direction D1 is less than 20% of the length Lt3 of the charge terminal member 120 in the attaching direction D1, the battery packs BP cannot easily be attached to the battery attaching units 36 due to the frictional force acting between the battery charge terminal members 160 of the battery packs BP and the insertion parts 132. According to the above configuration, the battery packs BP can easily be attached to the battery attaching units 36.

Further, the length Lt3 of each of the charge terminal members 120 of the terminal member units 64, 82, 100 in the attaching direction D1 is shorter than the length of each of the battery charge terminal members 160 of each of the battery packs BP in the attaching direction D1. The battery charge terminal member 160 of each of the battery packs BP comprises the upper charging clamp parts 166 (example of first clamp part) configured to clamp the charge terminal member 120; and the lower charging clamp parts 168 (example of second clamp part) configured to clamp the charge terminal member 120 and disposed on the attaching position side in the attaching direction D1 relative to the upper charging clamp parts 166. When each of the battery packs BP is attached to the one of the battery attaching units 36, the charge terminal members 120 of the terminal member units 64, 82, 100 are clamped by the lower charging clamp parts 168 without passing through the upper charging clamp parts 166.

In a general battery pack BP, its battery charge terminal members 160 are designed with long lengths for high-speed charging. In a configuration in which high-speed charging of the battery packs BP is not necessary, the charge terminal members 120 of the terminal member units 64, 82, 100 may be configured to contact only a part of the battery charge terminal members 160. By configuring the charge terminal members 120 of the terminal member units 64, 82, 100 to be clamped by the upper charging clamp parts 166, when the battery packs BP are to be attached to the battery attaching units 36, the charge terminal members 120 are clamped by the lower charging clamp parts 168 and pass therethrough, and are then clamped by the upper charging clamp parts 166. According to the above configuration, when the battery packs BP are to be attached to the battery attaching units 36, each charge terminal member 120 is clamped by the lower charging clamp parts 168 without passing through the upper charging clamp parts 166. Due to this, the battery packs BP can easily be attached to the battery attaching units 36 as compared to a configuration in which the charge terminal members 120 of the terminal member units 64, 82, 100 are clamped by the upper charging clamp parts 166.

Further, each of the battery packs BP is positioned at the attaching position when the battery pack BP is attached to the one of the battery attaching units 36. The battery pack BP moves to the attaching position by its own weight of the battery pack BP when the battery pack BP is attached to the battery attaching unit 36.

According to the above configuration, the battery packs BP can easily be attached to the battery attaching units 36.

Further, the accommodating box 2 is configured to be placed on the placement surface P1. When the accommodating box 2 is placed on the placement surface P1 and the battery packs BP are attached to the battery attaching units 36, each of the battery packs BP is inclined relative to the perpendicular plane P2 perpendicular to the placement surface P1.

According to the above configuration, the battery packs BP can easily be detached from the battery attaching units 36.

Further, the accommodating box 2 is configured to be placed on the placement surface P1. The case 6 has a box shape including the upper opening 12 and accommodates at least a part of each of the plurality of battery attaching units 36. The plurality of battery attaching units 36 comprises the front battery attaching unit 44 (example of first battery attaching unit) and the center battery attaching unit 46 (example of second battery attaching unit) arranged away from the front battery attaching unit 44 in the rear direction along the placement surface P1 (example of first direction). When the battery pack(s) BP is (are) attached to the front battery attaching unit 44, the battery pack(s) BP protrude toward the outside of the case 6 from the inside of the case 6 through the upper opening 12. When the battery pack(s) BP is (are) attached to the center battery attaching unit 46, the battery pack(s) BP protrude toward the outside of the case 6 from the inside of the case 6 through the upper opening 12. The protruding length Lb1 by which the battery pack(s) BP attached to the front battery attaching unit 44 protrude beyond the case 6 is longer than the protruding length Lb2 by which the battery pack(s) BP attached to the center battery attaching unit 46 protrude beyond the case 6.

When the battery packs BP are protruding from the case 6, the user can easily grab the battery packs BP by hands. According to the above configuration, when the battery pack(s) BP is (are) attached to each of the front battery attaching unit 44 and the center battery attaching unit 46, the user can grab the battery pack(s) BP attached to the front battery attaching unit 44 by hand and easily detach it (them) therefrom.

Further, each of the front battery attaching unit 44 and the center battery attaching unit 46 protrudes toward the outside of the case 6 from the inside of the case 6 through the upper opening 12. The protruding length La1 by which the front battery attaching unit 44 protrudes beyond the case 6 is longer than the protruding length La2 by which the center battery attaching unit 46 protrudes beyond the case 6.

According to the above configuration, when the battery pack(s) BP is (are) attached to each of the front battery attaching unit 44 and the center battery attaching unit 46, the user can grab the battery pack(s) BP attached to the front battery attaching unit 44 by hand and easily detach it (them) therefrom.

Further, the accommodating box 2 further comprises the case cover 8 configured to close the upper opening 12 of the case 6. The case cover 8 is attached to the case 6 such that the case cover 8 is movable relative to the case 6, and is configured to move between the closing position in which the case cover 8 closes the upper opening 12 of the case 6 and the opening position in which the case cover 8 opens the upper opening 12 of the case 6. The case cover 8 is disposed at a position away from the center battery attaching unit 46 in the rear direction when the case cover 8 is in the opening position.

When the case cover 8 is in the opening position, the user would stand on the opposite side from the case cover 8 relative to the center battery attaching unit 46 and attempt to detach the battery pack(s) BP from one of the battery attaching units 36. According to the above configuration, when the battery pack(s) BP is (are) attached to each of the front battery attaching unit 44 and the center battery attaching unit 46, the battery pack(s) BP can more easily be detached from the front battery attaching unit 44.

Further, the accommodating box 2 further comprises the case cover 8 configured to close the upper opening 12 of the case 6, and the cushioning member 180 attached to the case cover 8 and constituted of the elastic material. When the case cover 8 closes the upper opening 12 of the case 6, the cushioning member 180 is clamped between the battery pack(s) BP attached to the front battery attaching unit 44 and the case cover 8, and is clamped between the battery pack(s) BP attached to the center battery attaching unit 46 and the case cover 8. The push-in depth Dp1 by which the cushioning member 180 is pushed by the battery pack(s) BP attached to the front battery attaching unit 44 is substantially equal to the push-in depth Dp2 by which the cushioning member 180 is pushed by the battery pack(s) BP attached to the center battery attaching unit 46.

According to the above configuration, the force that acts from the cushioning member 180 on the battery pack(s) BP attached to the front battery attaching unit 44 becomes substantially equal to a force that acts from the cushioning member 180 on the battery pack(s) BP attached to the center battery attaching unit 46. Due to this, when the case cover 8 is closing the upper opening 12 of the case 6, the forces acting from the cushioning member 180 on the plurality of battery packs BP can be made substantially equal and the plurality of battery packs BP can be kept at predetermined positions.

Further, the case 6 has a box shape including the upper opening 12. The accommodating box 2 further comprises the case cover 8 configured to close the upper opening 12 of the case 6 and defining the accommodating space 18 between the case 6 and the case cover 8 when the upper opening 12 of the case 6 is closed. The plurality of battery attaching units 36 is disposed in the accommodating space 18. Each of the battery packs BP is positioned at the attaching position when the battery pack BP is attached to one of the battery attaching units 36. The case cover 8 keeps each of the battery packs BP in the attaching position relative to the one of the battery attaching units 36 when the upper opening 12 of the case 6 is closed.

According to the above configuration, when the case cover 8 is closing the upper opening 12 of the case 6, the battery packs BP can be suppressed from being displaced from their attaching positions relative to the battery attaching units 36.

Further, the accommodating box 2 further comprises the cushioning member 180 attached to the case cover 8 and configured to be clamped between the battery packs BP and the case cover 8 when the case cover 8 closes the upper opening 12 of the case 6. The cushioning member 180 is constituted of the elastic material.

Sizes of the battery packs BP may differ among the battery packs BP due to manufacturing tolerance. In a configuration in which the cushioning member 180 does not elastically deform, an excessive force could be applied to specific battery pack(s) BP from the case cover 8 when the case cover 8 closes the upper opening 12 of the case 6. According to the above configuration, even if the sizes of the battery packs BP differ among the battery packs BP, such application of the excessive force on the specific battery pack(s) BP from the case cover 8 can be suppressed by elastic deformation of the cushioning member 180.

Further, the accommodating box 2 comprises: the detection device 41 configured to detect that the upper opening 12 of the case 6 is closed by the case cover 8; and the control unit 38. The control unit 38 allows charging of the battery packs BP attached to the battery attaching units 36 when the detection device 41 detects that the upper opening 12 of the case 6 is closed by the case cover 8.

When the battery packs BP are displaced from the attaching positions, the battery packs BP cannot be charged correctly. According to the above configuration, since the battery packs BP are charged while being in the attaching positions, the battery packs BP can correctly be charged.

(Variants)

In an embodiment, the accommodating box 2 may comprise a power cable configured to connect to an external power source. In this configuration, the accommodating box 2 is configured to charge the battery packs BP by electrical power supplied from the external power source through the power cable.

In the embodiment, the battery attaching units 36 include three battery attaching units 44, 46, 48, however, in a variant, the numbers of the battery attaching units 44, 46, 48 may be two, or four or more.

In the embodiment, the number of the front battery attachment parts 68, the number of the center battery attachment parts 90, and the number of the rear battery attachment parts 108 may each be three or less or five or more.

The accommodating box 2 of an embodiment may further comprise a notification unit configured to notify a user that the charging of the battery packs BP is completed. The notification unit may for example be a display panel displaying an indication that the charging of the battery packs BP has been completed, may be a LED lamp that turns on or turns off when the charging of the battery packs BP is completed, or may be a notification means that notifies a portable terminal of the user (such as a smartphone) when the charging of the battery packs BP is completed.

The accommodating box 2 of an embodiment may not comprise the cushioning member 180. In this case, the battery packs BP are kept at their attaching positions by contacting the case cover 8.

The charge terminal members 120 of an embodiment may each be clamped only by one charging clamp part 164.

The charge terminal members 120 of an embodiment may each be clamped by both the upper charging clamp parts 166 and the lower charging clamp parts 168 of a corresponding one of the battery charge terminal members 160. In this case, the charge terminal member 120 is clamped by three or four charging clamp parts 164. In this configuration, the battery packs BP can be charged at high speed (such as within a few hours).

The terminal member units 64, 82, 100 of an embodiment may further comprise resin members to which the charge terminal members 120 and the communication terminal members 122 are fixed, and these resin members may be fixed to the holding members 60, 78, 96 by screws or insert molding. In doing so, the charge terminal members 120 and the communication terminal members 122 may be fixed to the resin members by insert molding or press-fitting.

What is claimed is:

1. An accommodating box configured to charge battery packs in a state in which the battery packs are accommodated in the accommodating box, the battery packs configured to be used by being attached to an electrical device, the accommodating box comprising:
a case; and
a plurality of battery attaching units supported by the case,
wherein
each of the battery packs is configured to be detachably attached to one of the plurality of the battery attaching units,
each of the battery packs comprises an engagement member configured to engage with the electrical device when the battery pack is attached to the electrical device, engagement between the battery pack and the electrical device being released by a user's operation on the engagement member,
each of the battery attaching units comprises:
a terminal member unit configured to be electrically connected to one of the battery packs when the battery pack is attached to the battery attaching unit; and
a holding member that holds the terminal member unit, and
the holding member is not engaged with the engagement member of the battery pack when the battery pack is attached to the battery attaching unit.

2. The accommodating box according to claim 1, wherein when each of the battery packs is attached to the one of the battery attaching units, the holding member is separated from the engagement member of the battery pack.

3. The accommodating box according to claim 1, wherein
each of the battery packs comprises a battery charge terminal member and a battery communication terminal member,
the terminal member unit comprises:
a charge terminal member configured to be electrically connected to the battery charge terminal member of the battery pack when each of the battery packs is attached to the one of the battery attaching units; and
a communication terminal member configured to be electrically connected to the battery communication terminal member of the battery pack when each of the battery packs is attached to the one of the battery attaching units,
each of the battery packs is attached to the one of the battery attaching units by the battery pack moving in an attaching direction relative to the battery attaching unit, and
a length of the charge terminal member of the terminal member unit in the attaching direction is 150% or less of a length of the communication terminal member of the terminal member unit in the attaching direction.

4. The accommodating box according to claim 3, wherein
the charge terminal member of the terminal member unit comprises:
a linear part extending along the attaching direction; and
an insertion part connected to an end of the linear part and tapering away from the linear part,
when each of the battery packs moves in the attaching direction relative to the one of the battery attaching units, the insertion part is inserted in the battery charge terminal member of the battery pack before the linear part is inserted in the battery charge terminal member, and
a length of the insertion part in the attaching direction is 20% or more of the length of the charge terminal member in the attaching direction.

5. The accommodating box according to claim 3, wherein
the length of the charge terminal member of the terminal member unit in the attaching direction is shorter than a length of the battery charge terminal member of each of the battery packs in the attaching direction,
the battery charge terminal member of each of the battery packs comprises:
a first clamp part configured to clamp the charge terminal member; and
a second clamp part configured to clamp the charge terminal member and disposed on an attaching position side in the attaching direction relative to the first clamp part, and
the charge terminal member of the terminal member unit is clamped by the second clamp part without passing through the first clamp part when each of the battery packs is attached to the one of the battery attaching units.

6. The accommodating box according to claim 3, wherein
each of the battery packs is positioned at an attaching position when the battery pack is attached to the one of the battery attaching units, and
the battery pack moves to the attaching position by its own weight of the battery pack when the battery pack is attached to the battery attaching unit.

7. The accommodating box according to claim 1, wherein
the accommodating box is configured to be placed on a placement surface, and
each of the battery packs is inclined relative to a perpendicular plane perpendicular to the placement surface when the accommodating box is placed on the placement surface and the battery pack is attached to the one of the battery attaching units.

8. The accommodating box according to claim 1, wherein
the accommodating box is configured to be placed on a placement surface,
the case has a box shape including an upper opening and accommodates at least a part of each of the plurality of battery attaching units,
the plurality of battery attaching units comprises:
a first battery attaching unit; and
a second battery attaching unit arranged away from the first battery attaching unit in a first direction which is along the placement surface,
the battery packs comprise a first battery pack and a second battery pack,
the first battery pack protrudes toward an outside of the case from an inside of the case through the upper opening when the first battery pack is attached to the first battery attaching unit,
the second battery pack protrudes toward the outside of the case from the inside of the case through the upper opening when the second battery pack is attached to the second battery attaching unit, and
a protruding length by which the first battery pack attached to the first battery attaching unit protrudes beyond the case is longer than a protruding length by which the second battery pack attached to the second battery attaching unit protrudes beyond the case.

9. The accommodating box according to claim 8, wherein
each of the first battery attaching unit and the second battery attaching unit protrudes toward the outside of the case from the inside of the case through the upper opening, and
a protruding length by which the first battery attaching unit protrudes beyond the case is longer than a protruding length by which the second battery attaching unit protrudes beyond the case.

10. The accommodating box according to claim 8, comprising a case cover configured to close the upper opening of the case,
wherein
the case cover is attached to the case such that the case cover is movable relative to the case, and is configured to move between a closing position in which the case cover closes the upper opening of the case and an opening position in which the case cover opens the upper opening of the case, and
the case cover is disposed at a position away from the second battery attaching unit in the first direction when the case cover is in the opening position.

11. The accommodating box according to claim 8, comprising:
a case cover configured to close the upper opening of the case; and
a cushioning member attached to the case cover and constituted of an elastic material,
wherein
when the case cover closes the upper opening of the case, the cushioning member is clamped between the first battery pack attached to the first battery attaching unit and the case cover and is clamped between the second battery pack attached to the second battery attaching unit and the case cover, and
a push-in depth by which the cushioning member is pushed by the first battery pack attached to the first battery attaching member is substantially equal to a push-in depth by which the cushioning member is pushed by the second battery pack attached to the second battery attaching member.

12. The accommodating box according to claim 1, wherein
the case has a box shape including an upper opening,
the accommodating box comprises a case cover configured to close the upper opening of the case and defining an accommodating space between the case and the case cover when the upper opening of the case is closed,
the plurality of battery attaching units is disposed in the accommodating space,
each of the battery packs is positioned at an attaching position when the battery pack is attached to the one of the battery attaching units, and
the case cover keeps each of the battery packs in the attaching position relative to the one of the battery attaching units when the upper opening of the case is closed.

13. The accommodating box according to claim 12, comprising a cushioning member attached to the case cover and configured to be clamped between the battery packs and the case cover when the case cover closes the upper opening of the case,
wherein
the cushioning member is constituted of an elastic material.

14. The accommodating box according to claim 12, comprising:
a detection device configured to detect that the upper opening of the case is closed by the case cover; and
a control unit,
wherein
the control unit allows charging of the battery packs attached to the battery attaching units when the detection device detects that the upper opening of the case is closed by the case cover.

15. The accommodating box according to claim 2, wherein
each of the battery packs comprises a battery charge terminal member and a battery communication terminal member,
the terminal member unit comprises:
a charge terminal member configured to be electrically connected to the battery charge terminal member of the battery pack when each of the battery packs is attached to the one of the battery attaching units; and
a communication terminal member configured to be electrically connected to the battery communication terminal member of the battery pack when each of the battery packs is attached to the one of the battery attaching units,
each of the battery packs is attached to the one of the battery attaching units by the battery pack moving in an attaching direction relative to the battery attaching unit, and a length of the charge terminal member of the terminal member unit in the attaching direction is 150% or less of a length of the communication terminal member of the terminal member unit in the attaching direction,
the charge terminal member of the terminal member unit comprises:
a linear part extending along the attaching direction; and
an insertion part connected to an end of the linear part and tapering away from the linear part,
when each of the battery packs moves in the attaching direction relative to the one of the battery attaching units, the insertion part is inserted in the battery charge terminal member of the battery pack before the linear part is inserted in the battery charge terminal member,
a length of the insertion part in the attaching direction is 20% or more of the length of the charge terminal member in the attaching direction,
the length of the charge terminal member of the terminal member unit in the attaching direction is shorter than a length of the battery charge terminal member of each of the battery packs in the attaching direction,
the battery charge terminal member of each of the battery packs comprises:
a first clamp part configured to clamp the charge terminal member; and
a second clamp part configured to clamp the charge terminal member and disposed on an attaching position side in the attaching direction relative to the first clamp part,
the charge terminal member of the terminal member unit is clamped by the second clamp part without passing through the first clamp part when each of the battery packs is attached to the one of the battery attaching units,
each of the battery packs is positioned at an attaching position when the battery pack is attached to the one of the battery attaching units,
the battery pack moves to the attaching position by a weight of the battery pack when the battery pack is attached to the battery attaching unit,
the accommodating box is configured to be placed on a placement surface,
each of the battery packs is inclined relative to a perpendicular plane perpendicular to the placement plane when the accommodating box is placed on the placement surface and the battery pack is attached to the one of the battery attaching units,
the case has a box shape including an upper opening and accommodates at least a part of each of the plurality of battery attaching units,
the plurality of battery attaching units comprises:
a first battery attaching unit; and
a second battery attaching unit arranged away from the first battery attaching unit in a first direction which is along the placement surface,
the battery packs comprise a first battery pack and a second battery pack, the first battery pack protrudes toward an outside of the case from an inside of the case through the upper opening when the first battery pack is attached to the first battery attaching unit,
the second battery pack protrudes toward the outside of the case from the inside of the case through the upper opening when the second battery pack is attached to the second battery attaching unit,
a protruding length by which the first battery pack attached to the first battery attaching unit protrudes beyond the case is longer than a protruding length by which the second battery pack attached to the second battery attaching unit protrudes beyond the case,
each of the first battery attaching unit and the second battery attaching unit protrudes toward the outside of the case from the inside of the case through the upper opening,
a protruding length by which the first battery attaching unit protrudes beyond the case is longer than a protruding length by which the second battery attaching unit protrudes beyond the case,
the accommodating box comprises a case cover configured to close the upper opening of the case,
the case cover is attached to the case such that the case cover is movable relative to the case, and is configured to move between a closing position in which the case cover closes the upper opening of the case and an opening position in which the case cover opens the upper opening of the case,
the case cover is disposed at a position away from the second battery attaching unit in the first direction when the case cover is in the opening position,
the accommodating member comprises a cushioning member attached to the case cover and constituted of an elastic material,
when the case cover closes the upper opening of the case, the cushioning member is clamped between the first battery pack attached to the first battery attaching unit and the case cover and is clamped between the second battery pack attached to the second battery attaching unit and the case cover,
a push-in depth by which the cushioning member is pushed by the first battery pack attached to the first battery attaching member is substantially equal to a pushing depth by which the cushioning member is pushed by the second battery pack attached to the second battery attaching member,
a case cover is configured to define an accommodating space between the case and the case cover when the upper opening of the case is closed,
the plurality of battery attaching units is disposed in the accommodating space,
each of the battery packs is positioned at an attaching position when the battery pack is attached to the one of the battery attaching units,
the case cover keeps each of the battery packs in the attaching position relative to the one of the battery attaching units when the upper opening of the case is closed,
the accommodating box comprises:
a detection device configured to detect that the upper opening of the case is closed by the case cover; and
a control unit, and
the control unit allows charging of the battery packs attached to the battery attaching units when the detection device detects that the upper opening of the case is closed by the case cover.
